(19) United States
(12) Patent Application Publication
(10) Pub. No.: US 2023/0243690 A1
(43) Pub. Date: Aug. 3, 2023

(54) FLUID TANK REMOTE MONITORING NETWORK WITH PREDICTIVE ANALYSIS

(71) Applicant: Whammy, Inc., Millbrook, NY (US)

(72) Inventors: Grant Kenji Larsen, Millbrook, NY (US); Andrew Heaney, Millbrook, NY (US)

(21) Appl. No.: 18/154,064

(22) Filed: Jan. 13, 2023

Related U.S. Application Data
(60) Provisional application No. 63/299,513, filed on Jan. 14, 2022.
(60) Provisional application No. 63/299,518, filed on Jan. 14, 2022.
(60) Provisional application No. 63/299,524, filed on Jan. 14, 2022.
(60) Provisional application No. 63/299,527, filed on Jan. 14, 2022.
(60) Provisional application No. 63/299,531, filed on Jan. 14, 2022.
(60) Provisional application No. 63/299,542, filed on Jan. 14, 2022.
(60) Provisional application No. 63/299,544, filed on Jan. 14, 2022.

(51) Int. Cl. G01F 23/80; G01F 23/62; G16Y 40/10; G16Y 20/10

(52) U.S. Cl. CPC G01F 23/804; G01F 23/62; G16Y 20/10; G16Y 40/10

(57) ABSTRACT

A network of wireless nodes which collect data from a sensor on a fluid tank and uploads the data to the cloud or Internet. The network allows for a temporary node to integrate into the network such that technicians can access the network without access to the cloud or internet. Further, local data is compared to data over a greater region in order to determine the difference between the specific location of the fluid tank and the larger region to produce predictive fluid tank parameter data. Then the fluid tank parameters are adjusted based on the predictive data so the environmental effects on the fluid tank are better managed.

### RELATED APPLICATIONS

Under provisions of 35 U.S.C. §119(e), the Applicant claims benefit of U.S. Provisional Application No. 63/299,513 filed on Jan. 14, 2022, U.S. Provisional Application No. 63/299,518 filed on Jan. 14, 2022, U.S. Provisional Application No. 63/299,524 filed on Jan. 14, 2022, U.S. Provisional Application No. 63/299,527 filed on Jan. 14, 2022, U.S. Provisional Application No. 63/299,531 filed on Jan. 14, 2022, U.S. Provisional Application No. 63/299,542 filed on Jan. 14, 2022, and U.S. Provisional Application No. 63/299,544 filed on Jan. 14, 2022, and having inventors in common, which are incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF THE DISCLOSURE

The present disclosure is generally related to remote monitoring network infrastructure and more particularly to a fluid tank remote monitoring network with predictive analysis.

### BACKGROUND

Many modern appliances, machines, and systems, such as stovetops, heaters, or even door locks, are not built to be monitored and controlled remotely. Fortunately, some technologies have allowed remote access and control of such devices through wireless networks such as the internet or even local wireless mesh networks in and around a home or other structure.

However, many of these technologies do not work with existing systems but instead may require a homeowner to upgrade to a “smart appliance.” Further, these remote networks often require access to the internet and become difficultto troubleshoot when connectivity is at issue.

For some systems, such as propane tanks which are often stored far from other systems for safety, a wireless connection may require repeater nodes to extend the signal. When one of these nodes needs replacement or repair, it may be difficult to discern which node is the problem. Technicians may need to access data from other nodes on the local mesh directly and wirelessly.

An additional problem these systems face is that the local environment may differ from the greater region. For example, tanks may be stored underground, a home may be at a higher altitude than the residential area it resides in, or a water tower may be partially shaded at certain points of the day. Therefore, a system for predictive measurements from the regional environment that may need to be adjusted to compensate for the locality is desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter’s scope.

One embodiment of the present disclosure provides a system for a fluid tank remote monitoring network with predictive analysis. The system includes a processor of a prediction node connected to a fluid tank sensor node, an environment sensor node and to a user device over a remote network; a memory on which are stored machine-readable instructions that when executed by the processor, cause the processor to: query an admin database for new data acquired from the fluid tank sensor node and from the environment sensor node, extract a tank ID from the new data, retrieve from the admin database entries corresponding to the tank ID, retrieve a local environment parameter from the entries, search a measurement database for a regional parameter corresponding to the local environment parameter, calculate a difference between values of the local environment parameter and the regional parameter, and predict a fluid tank parameter based on the calculated difference.

Another embodiment of the present disclosure provides a method that includes one or more steps of querying an admin database for new data acquired from a fluid tank sensor node and from an environment sensor node, extracting a tank ID from the new data, retrieving from the admin database entries corresponding to the tank ID, retrieving a local environment parameter from the entries, searching a measurement database for a regional parameter corresponding the local environment parameter, calculating a difference between values of the local environment parameter and the regional parameter, and predicting a fluid tank parameter based on the calculated difference.

Another embodiment of the present disclosure provides a computer-readable medium including instructions for querying an admin database for new data acquired from a fluid tank sensor node and from an environment sensor node, extracting a tank ID from the new data, retrieving from the admin database entries corresponding to the tank ID, retrieving a local environment parameter from the entries, searching a measurement database for a regional parameter corresponding the local environment parameter, calculating a difference between values of the local environment parameter and the regional parameter, and predicting a fluid tank parameter based on the calculated difference.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### DESCRIPTIONS OF THE DRAWING

The accompanying drawings, which are incorporated in and constitute a part of this disclosure, illustrate various embodiments of the present disclosure. The drawings may contain text or captions that may explain certain embodiments of the present disclosure. This text is included for illustrative, non-limiting, explanatory purposes of certain embodiments detailed in the present disclosure. In the drawings:

FIG. 1 illustrates a system for fluid tank management, consistent with disclosed embodiments.

FIG. 2 illustrates an admin database, consistent with disclosed embodiments.

FIG. 3 illustrates a local estimate module, consistent with disclosed embodiments.

FIG. 4 illustrates a measurement database, consistent with disclosed embodiments.

FIG. 5 illustrates a system for fluid tank management, according to a disclosed embodiment.

FIG. 6 illustrates an admin database, according to a disclosed embodiment.

FIG. 7 illustrates a generic analysis module, according to a disclosed embodiment.

FIG. 8 illustrates an individual analysis module, according to a disclosed embodiment.

FIG. 9 illustrates a system for fluid tank management, according to a disclosed embodiment.

FIG. 10 illustrates an admin database, according to a disclosed embodiment.

FIG. 11 illustrates an expected levels module, according to a disclosed embodiment.

FIG. 12 illustrates a data correction module, according to a disclosed embodiment.

FIG. 13 illustrates a system for fluid tank management, according to a disclosed embodiment.

FIG. 14 illustrates an admin database, according to a disclosed embodiment.

FIG. 15 illustrates an expected refill module, according to a disclosed embodiment.

FIG. 16A illustrates a fluid usage graph showing fluid usage at various humidities, according to a disclosed embodiment.

FIG. 16B illustrates a fluid usage graph showing fluid usage at various temperatures, according to a disclosed embodiment.

FIG. 16C illustrates a fluid usage graph showing fluid usage on various days of the month, according to a disclosed embodiment.

FIG. 16D illustrates a fluid usage graph showing fluid usage on various days of the week, according to a disclosed embodiment.

FIG. 17 illustrates a system for fluid tank management, according to a disclosed embodiment.

FIG. 18 illustrates an admin database, according to a disclosed embodiment.

FIG. 19 illustrates a route module, according to a disclosed embodiment.

FIG. 20 illustrates a route rules database, according to a disclosed embodiment.

FIG. 21 illustrates a correction module, according to a disclosed embodiment.

FIG. 22 illustrates a system for fluid tank management, according to a disclosed embodiment.

FIG. 23 illustrates an admin database, according to a disclosed embodiment.

FIG. 24 illustrates a data output module, according to a disclosed embodiment.

FIG. 25 illustrates a data input module, according to a disclosed embodiment.

FIG. 26 illustrates a system consistent with an embodiment of the disclosure.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

As a preliminary matter, it will readily be understood by one having ordinary skill in the relevant art that the present disclosure has broad utility and application. As should be understood, any embodiment may incorporate only one or a plurality of the disclosed aspects of the disclosure and may further incorporate only one or a plurality of the disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a fluid tank remote monitoring network, embodiments of the present disclosure are not limited to use only in this context.

The disclosed embodiments may be used in any field requiring measurement of a remotely deployed site, mobile or stationary. Such measurement may be of a continuous value, such as the battery’s voltage or the volume of liquid in a tank. Such measurement may be a discrete value (binary or otherwise), such as the state of an indicator light, the presence or absence of liquid, audio levels above a threshold, or other defined discrete levels that a sensor of any type may be able to report. One example field of use for the disclosed embodiments is the field of delivery and/or level maintenance of fluid fuels (including, but not limited to propane, fuel oil, or other fluid fuels), where the measurement is of continuous values of fluid fuel amount and battery voltages of the measurement nodes.

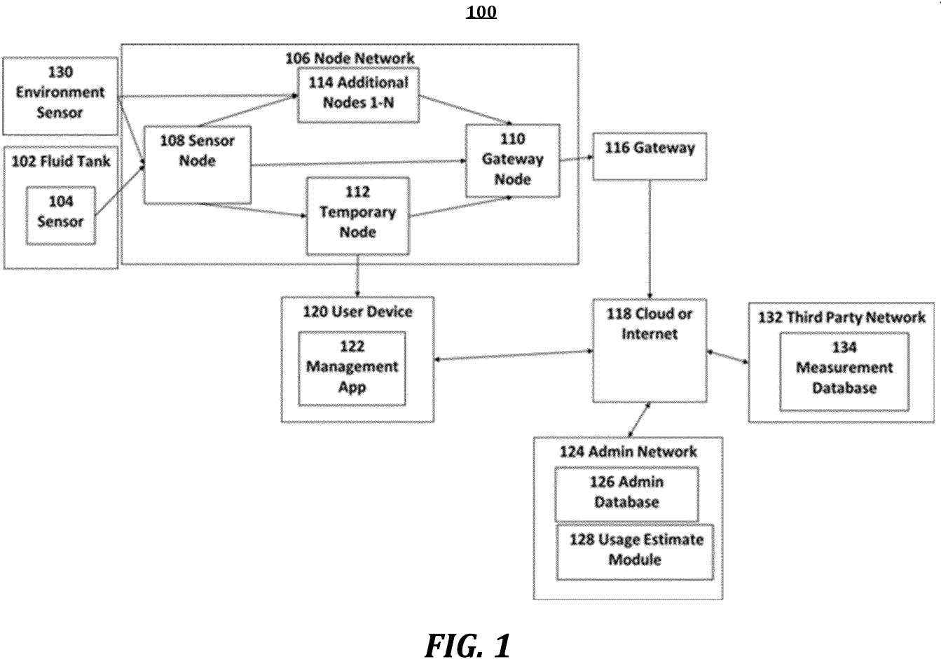

FIG. 1 shows an embodiment of a system 100 for fluid tank management. This system includes a fluid tank 102, which may be any container that contains a fluid. For example, a propane tank, an oxygen tank, a water bottle, a canister of liquid nitrogen, a bag of saline solution, a container of pressurized carbon dioxide, etc. A sensor 104 may be a device that detects at least one parameter or property of the fluid tank 102, such as (but not limited to) fluid level, pressure, temperature, etc. For example, the sensor 104 may detect a fluid level using a hall effect sensor that detects the movement of a magnet that is connected to a float inside a propane tank. The sensor 104 may be connected to a gateway device 116 and/or a user device 124 by a network 106.

In some embodiments, the network 106 may be formed as a node network, a hub and spoke network, or any other network architecture suitable for conveying data between the sensor 104 and the gateway device 116 and/or user device 120. In some embodiments, the network 106 may include one or more additional devices, such as a repeater, a bridge, a router, a switch, and/or an extender. Data may be communicated between devices within the network using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to or from other nodes or other elements of the system such as the sensor 104, the gateway device 116, or the user device 124.

Each node may represent, for example, a communication endpoint and/or a redistribution point within the network. A node may include an electronic device attached to a network and capable of creating, receiving, and/or transmitting information. Nodes may be self-contained wireless communication devices that are able to communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc. The nodes in the network 106 may be contained within other system elements, such as, but not limited to, the gateway device 116 and/or the sensor 104. Nodes may be contained in a housing, such as a plastic container containing space for the electronics that comprise the node.

A node may refer to the electronics that perform the communications or refer to both electronics and housing. The network 106 may be comprised of three nodes: a sensor node 108, which is fixed near or at the sensor 102, a gateway node 110, which is fixed near or at the gateway device 116, and a temporary node 112, which is mobile or otherwise temporary. In some embodiments, the network 106 may include additional nodes 114 to create a mesh network, a hub and spoke network, a linear topology network, or any other network topology for communicating data among the network nodes, and/or to provide additional network functionality. Some of the additional nodes may be alternate versions of the three nodes discussed above (e.g., the sensor node 108, the gateway node 110, and the temporary node 112). For example, there may be two nodes that are fixed near the sensor 102, both of which may be sensor nodes 108 such that if one node fails, the other node can still transmit data from the sensor 104 to other nodes on the network 106. Additional nodes 114 may also be intermediate nodes that neither receive data directly from the sensor 104 nor transmit data directly to the gateway device 116, but instead transfer data from one node to another to increase the range of the signal, ensure data integrity, or facilitate the integration of the temporary node 112 into the network 106.

A sensor node 108, may be a node that receives data from the sensor 104. Data may be transmitted to the node via wired or wireless communication from the sensor 104. The sensor node 108 may be configured to read data from the sensor if the sensor is analog. There may be more than one sensor node 108, which node is the sensor node 108 may change based on connection strength between the sensor and nodes in the network 106. The sensor node 108 may be connected to the sensor 104, which may detect a parameter, such as fluid level, of the fluid tank 102. For example, the sensor 104 may read the position of the level gauge needle on the propane tank. The sensor node 108 may be attached to a support, which allows it to mount to the fluid tank 102 and/or the sensor 104. Due to obstacles and/or obstructions, the sensor node 108 may not be able to directly communicate with the gateway node 110. One or more additional nodes 114 may be placed in a location that allows it to relay wireless communications around obstacles and obstructions.

In cases where there is little or no obstruction, the gateway node 110 and the sensor node 108 may be the same node. A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap.

This is the normal round trip of measurement data transmission and acknowledgment reception. When the admin network 124 receives the data, it may log these data, run a trend analysis or other analysis, and/or may initiate a service action based on the received data. Such action may be, as a non-limiting example, routing a propane delivery because the tank level is low, and other logistical factors contribute to the conclusion to make such delivery. Alternatively, the service action may be related to network maintenance, such as if any of the nodes in the network 106 reported that its battery is low enough to require replacement, initiating the replacement. Such replacement may be of the battery or may be of an entire node.

A temporary node 112 may be a node that connects to the network 106 temporarily in order to send and receive data from other nodes. This data may then be passed on to the gateway node 110 or other nodes in the network. These nodes may be mobile, such that one node could join multiple networks 106 based on proximity. The temporary node 112 may send data directly to the user device 120 when access to the cloud or internet 118 is unavailable. For example, a service technician may carry a temporary node 112 so that they can integrate with any network 106 and access data via a user device 120 without being connected to the cloud or internet 118. The temporary node 112 may be a node that has augmented equipment allowing direct display of network parameters and command functions to the user. In this case, the user may be a service representative. Such a node may be required for network maintenance, especially if the gateway device 116 is unavailable, rendering the local RF network “invisible” to the remote system. If the gateway device 116 and internet connectivity is operational, then an alternate method for the service person to use would be accessing the network information via a user device 120 or a web page associated with the admin network 124 on an internet-connected device. The temporary node 112 may not be ported or carried by the service person but instead the delivery or service vehicle. Valuable data may be obtained by understanding when this temporary node may have joined a local network and how long it was present. If attached to a delivery vehicle, the temporary node 112 may have its own measurement module(s) and may be able to provide data about the transfer from a tank on the vehicle to the fluid tank 102. Zero or more additional nodes 114, which may facilitate the communication of data within the network 106. For example, if the sensor node 108 is too far from the gateway node 110 to communicate, or there is an obstruction that is blocking communication, then additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem which sends data directly to the cloud or internet 118, or may be a router that sends data to a modem which then sends data to the cloud or internet 118. The cloud or internet 118 may be a wired and/or a wireless network. The network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. At the same time, third-party clouds enable organizations to focus on their core businesses instead of expending resources on computer infrastructure and maintenance. A user device 120, which may be any device that can receive information from the cloud or internet 118 such as a laptop, smartphone, tablet, computer, or smart speaker. The user device 120 may also be a device that can receive or send information to one or more nodes on the network 106.

A management app 122 may be an application on the user device 120, which is able to display information related to the fluid tank 102 obtained from the admin network 124 and/or directly from the network 106. The management app 122 may allow a user or service technician to affect elements of the system. As non-limiting examples, the management app 122 may be able to remotely drain the fluid tank 102, cut off the flow of fluid out of the fluid tank 102, reset the network 106, etc. The management app 122 may allow a user to receive information from and control the system. The user may be the owner or user of the fluid tank 102, a technician, an agent of a tank refilling company, a regulator, etc. The management app 122 may receive data from the admin network 124 if a connection to the network is available. If a connection to the admin network 124 is unavailable, the management app 122 may connect directly to the network 106. Connection to the network 106 may require proximity to at least one node on the network. This node may be the temporary node 112, which may be part of, or otherwise connected to, the user device 120.

For example, the user device 120 may be a smartphone attached via a wired connection (e.g., a USB-c cable) to a temporary node 112. The temporary node 112 may sync up to a nearby network 106 such that the user device 120 can obtain information from the network 106 through the connection with the temporary node 112. The user device 120 and temporary node 112 may be the same device or may be housed in the same container. For example, a handheld tablet which contains an RFID communication device that is able to receive data from the network 106 may serve as both the user device 120 and the temporary node 112. The management app 122 may then display the data from the admin network 124 or network 106 to the user. The user may be able to navigate through the management app 122 in order to view, format, and filter the data. The user may then be able to make changes to the system using the management app 122, for example, requesting early refueling, rebooting a node or the network 106, controlling which data is sent to the admin network 124, etc. Additional elements of the system may also be controlled through the management app 122.

For example, an emergency shut-off valve may be controlled remotely by being activated through the management app 122. Management of various aspects of the system may be automated through the management app 122. For example, when the fluid level in the fluid tank 102 begins to drop more rapidly than normal, an emergency shut-off valve may be activated without user intervention.

An admin network 124 may be a computer or network of computers that receives data associated with the fluid tank 102 through the cloud or internet 118. This data may then be stored, sent, altered, and/or used in programs or modules. An admin database 126 may contain data received by the admin network 124. The admin database 126 may contain a record of all received data associated with the fluid tank 102 over time. The admin database 126 may contain data from multiple instances of this system. The admin database 126 may contain data from other sources such as weather data, data from the fluid tank 102 manufacturers, data provided by a user of the system, etc.

A local (usage) estimate module 128 may be any device configured to estimate fluid usage in the tank 102 based on historical data in the admin database 126. This historical data may include combinations of both fluid tank 102 data and environment sensor 130 data. For example, fluid tank 102 levels in a propane tank may drop faster than average when the temperature is low because more propane is being used to heat a house. The local estimate module 128 may send estimate data to the user device 120.

An environment sensor 130 may be a device that detects environmental parameters such as, but not limited to, one or more of temperature, humidity, sunlight, wind speed, etc. The environment sensor 130 may be located at the fluid tank 102 or near enough to the fluid tank that the measurements made by the sensor 130 are relevant. The environment sensor 130 may send data via the network 106 to the admin network 124.

The environment sensor 130 may send data to the sensor node 108 or another node on the network 106. A third-party network 132 may be a computer or network of computers that contain data on current or predicted environmental parameters such as temperature, humidity, sunlight, wind speed, etc. For example, the network of a weather prediction company. A measurement database 134 may contain data on current and/or predicted environmental parameters such as temperature, humidity, sunlight, wind speed, etc., received from one or more environmental sensors 130 and/or one or more third party networks 132.

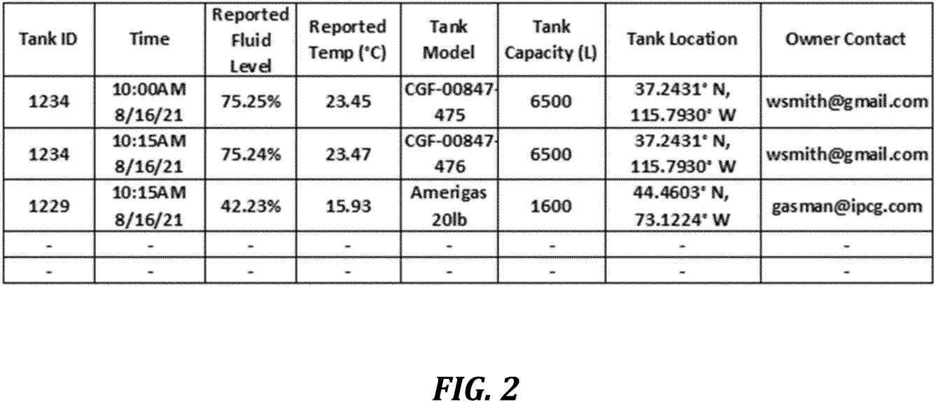

FIG. 2 displays an embodiment of the admin database 126. The admin database 126 may contain identifying information for a fluid tank 102. For example, a tank ID, the make or model of the tank, the location of the tank, and/or contact information for the owner or manager of a tank may be stored in the admin database 126. The admin database 126 may also contain the data related to the fluid tank 102. As one example shown in FIG. 2, the data may include a fluid level of the tank 102. This data may be timestamped and may be saved in the database continuously, at regular intervals, such as every 5 minutes, every 15 minutes, every hour, etc., or at irregular intervals based on measured, calculated, and/or anticipated usage. In embodiments, the admin database 126 may also contain environmental data, such as data from one or more environmental sensors 130 and/or one or more third party networks 132. The admin database 126 may also contain features of the tank that would be useful in determining when the tank will need to be filled, such as the total tank capacity. Some of this data, such as tank capacity, may be obtained from sources outside of the admin network 124, such as the manufacturer’s website. The admin database 126 may contain additional data received from the network 106, such as temperature or weather data.

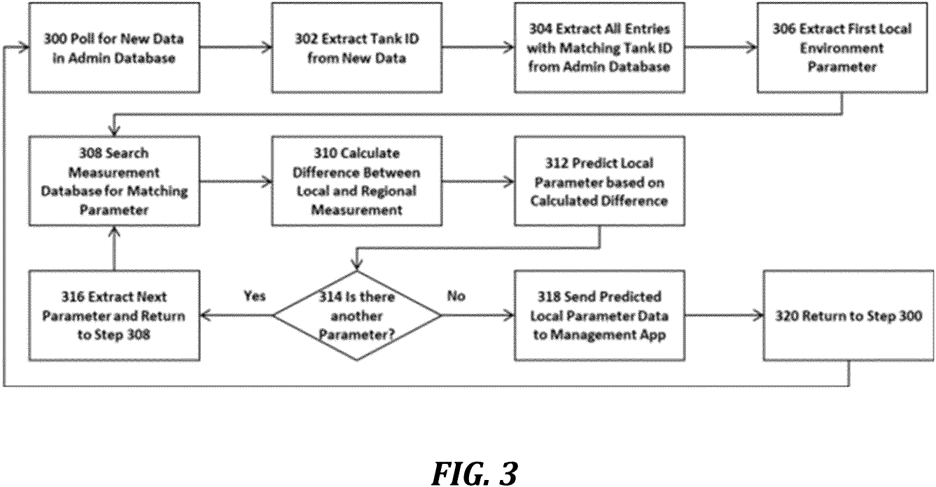

Functioning of the Local Estimate Module 128 will now be explained with reference to FIG. 3.

The functions performed in the processes and methods described herein may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 displays the functioning of the Local Estimate Module 128 (see FIG. 1). The process may begin at step 300 with the Local Estimate Module 128 polling for new data in the admin database 126. New data may refer to newly created or updated data stored in the admin database 126. At step 302, the local estimate module 128 may extract the tank ID from the new data entry in the admin database 126. The local estimate module 128 may, at step 304, extract all entries in the admin database 126 with a tank ID that matches the tank ID extracted in step 302. The extracted data entries may correspond to all current and historical data related to a particular fluid tank.

At step 306, the local estimate module 128 may extract the first local environmental parameter from all of the matching entries. The local estimate module may extract a time associated with each of the environmental parameter entries. For example, if the first parameter is temperature, then each temperature recorded locally at the fluid tank and each associated time that temperature measurement was recorded would be extracted from the data. In some embodiments, time may be substituted for another parameter.

At step 308, the local estimate module 128 may search the measurement database 134 for data matching the extracted parameters. In some embodiments, the matching data may be narrowed by region, such as the region in which the fluid tank resides or a nearby region. The local estimate module 128 may collect data from nearby regions or may select a larger region if the amount of data for the nearest region is incomplete or insufficient.

The local estimate module 128 may calculate the difference between the value of the selected parameter locally and regionally at step 310. For example, if the temperature at or near the fluid tank is 95° F. and the regional temperature is 88° F., the local temperature is 7° F. higher. This difference may be calculated for one or more (e.g., each) point in time where there is both local and regional data.

In embodiments, each of the one or more individual differences may be used to create an estimate for future differences. In some embodiments, the one or more individual differences may be determined algorithmically. For example, the average of all differences may be +5.6° F., and the predicted temperature for the region is 90° F. then the predicted temperature at or near the fluid tank may be 95.6° F. The difference formula may not be a fixed value but may be a function of time. For example, the difference between the regional and local temperature may be larger during the day than at night, and the difference formula may compensate for this discrepancy. A fluid tank in direct sunlight may heat up faster than the regional environment. In which case the adjustment factor may be the minimum adjustment, for example, 2° F., at 6 am when the fluid tank has not been in sunlight and is closest to the ambient temperature, the maximum adjustment, for example, 18° F., at 6 pm when the ambient temperature is dropping, but the fluid tank has been in direct sunlight for multiple hours, and an intermediate adjustment value which may begin at the minimum, rises to the maximum, and fall to the minimum again over the course of the day. The local estimate module 128 may use other local or regional parameters to determine the adjustment formula. In other embodiments, the one or more individual differences may be determined without using algorithmic processing. For example, one or more artificial intelligence and/or machine learning techniques may be used to determine the one or more individual differences.

At step 312, the local estimate module 128 may predict the local parameter based on the difference formula calculated in step 310. The prediction may be for a single point in time or for multiple points in time for which there is a regional prediction. The local estimate module 128 may later check if the local prediction matches the local data collected from an environment sensor. If the local prediction does not accurately estimate the actual local environment, the adjustment formula may be altered until the predictions become more accurate over time.

At step 314, the local estimate module 128 may determine if there is another parameter in the admin database 126, such as sun exposure, humidity, pressure, etc. Which parameters are in the admin database 126 may depend on which data the environmental sensor can collect.

Other parameters may have different adjustment formulas based on the characteristics of the parameter. For example, while the temperature may always be adjusted in the same direction, local pressure changes may be more extreme in both directions than the regional pressure. Therefore, instead of an average difference, the formula may adjust the amplitude of a sine wave or other curve that maps to the change in regional pressure over the course of the day. When the regional pressure is lowest, the local pressure may be even lower, but when the regional pressure is highest, the local pressure may be even higher. In this case, the adjustment formula may compare the regional change to a baseline pressure average, then multiply that change by a factor to predict local pressure. When the regional pressure is 10% lower than average, the adjustment formula may predict that the local pressure is 15% lower than average. When the regional pressure is expected to be 10% higher than average, the predicted local pressure may be 15% higher than average.

If another parameter is in the admin database 126 (YES at step 314), the local estimate module 128 may extract the next parameter and return to step 308, at step 316. Thereafter, the process may return to step 308 using the next parameter.

If there is not another parameter in the admin database 126 (NO at step 314), the local estimate module 128 may send the predicted local parameter data to the management app 122 at step 318. In some embodiments, the management app 122 may display at least a portion of the predicted local parameter data to the user, and/or use the data to manage one or more parts of the system. The predicted local parameter data may be stored on the admin network 124 (e.g., in the admin database 126 or another database).

The local estimate module 128 may return to step 300 at step 320.

In some embodiments, the predicted local parameter data may be determined through machine learning and/or artificial intelligence. Machine learning may leverage artificial intelligence to allow a computer process to improve itself automatically over time without being explicitly programmed. Machine learning processes can develop a framework for analyzing a data set through experience in using that data. Machine learning helps create models that can process and analyze large amounts of complex data to deliver accurate results. Machine learning uses models or mathematical representations of real-world processes. It achieves this through examining features, measurable properties, and parameters of a data set. It may utilize a feature vector, or a set of multiple numeric features, as a training input for prediction purposes. A process may receive a set of data known as “training data” as input. The process finds patterns in the input data and trains the model for expected results (target).

The output of the training process is the machine learning model. A model may then make a prediction when fed input data. The value that the machine learning model has to predict is called the target or label. When large amounts of data are fed to a machine learning model, it may experience overfitting, a situation in which the machine learning model learns from noise and inaccurate data entries. Overfitting may result in data being labeled incorrectly or in predictions being inaccurate. A machine learning model may experience underfitting when the model fails to decipher the underlying trend in the input data set as it does not fit the data well enough.

A machine learning system may measure error once the model is trained. New data may be fed to the model, and the outcome may be checked and categorized into one of four types of results: true positive, true negative false positive, and false negative. A true positive result is when the model predicts a condition when the condition is present. A true negative result is when the model does not predict a condition when it is absent. A false-positive result is when the model predicts a condition when it is absent. A false negative is when the model does not predict a condition when it is present. The sum of false positives and false negatives is the total error in the model. While an algorithm or hypothesis can fit well to a training set, it might fail when applied to another data set outside the training set. It must therefore be determined if the algorithm is fit for new data. Testing the algorithm with a set of new data is the way to judge this. Generalization refers to how well the model predicts outcomes for new sets of data. Noise must also be managed and data parameters tested. A machine learning system may go through several cycles of training, validation, and testing until the error in the model is brought within an acceptable range.

A machine learning system may use one or more types of machine learning. Supervised machine learning algorithms can use data that has already been analyzed, by a person or another algorithm, to classify new data. Analyzing a known training dataset allows a supervised machine learning algorithm to produce an inferred function to predict output values in the new data. As input data is fed into the model, it changes the weighting of characteristics until the model is fitted appropriately. This supervised learning is part of a process to ensure that the model avoids overfitting or underfitting called cross-validation. Supervised learning helps organizations solve various real-world problems at scale, such as classifying spam in a separate email folder.

Supervised machine learning algorithms are adept at dividing data into two categories, or binary classification, choosing between more than two types of answers, or multi-class classification, predicting continuous values, or regression modeling, or combining the predictions of multiple machine learning models to produce an accurate prediction, also known as ensembling. Some methods used in supervised learning include neural networks, naive Bayes, linear regression, logistic regression, random forest, support vector machine (SVM), and more. A supervised machine learning system may be provided a dataset of historical fluid levels and context features, such as the date, temperature device usage, etc., and use that data to predict the fluid level based on historical characteristics. A machine learning system may utilize recommendation algorithms to learn fluid use patterns for different sensors in different contexts.

For example, a supervised machine learning algorithm may identify that, while decreased temperature always has a positive correlation with fluid use in a home heating system, a clear day that follows snowfall may significantly reduce the fluid use due to the reflected light off of the snow raising the temperature in a given user’s home. Unsupervised machine learning analyzes and clusters data that has not been analyzed yet to discover hidden patterns or groupings within the data without the need for a human to define what the patterns or groupings should look like. The ability of unsupervised machine learning algorithms to discover similarities and differences in information makes it the ideal solution for exploratory data analysis, cross-selling strategies, customer segmentation, image, and pattern recognition. Most types of deep learning, including neural networks, are unsupervised algorithms.

Unsupervised machine learning may be utilized in dimensionality reduction or the process of reducing the number of random variables under consideration by identifying a set of principal variables. Unsupervised machine learning may split datasets into groups based on similarity, also known as clustering. Unsupervised machine learning may be used in anomaly detection by identifying unusual data points in a data set. In some embodiments, unsupervised machine learning may be used to identify items in a data set that frequently occur together, also known as association mining. Principal component analysis and singular value decomposition are two methods of dimensionality reduction that may be employed. Other algorithms used in unsupervised learning include neural networks, k-means clustering, probabilistic clustering methods, and more.

A machine learning system may fall between a supervised machine learning algorithm and an unsupervised one. In these systems, an algorithm used training on a smaller labeled dataset to identify features and classify a larger, unlabeled dataset. These types of algorithms perform better when provided with labeled data sets. However, labeling can be time-consuming and expensive, which is where unsupervised learning can provide efficiency benefits.

Reinforcement learning is when data scientists teach a machine learning algorithm to complete a multi-step process with clearly defined rules. The algorithm is programmed to complete a task and is given positive and negative feedback or cues as it works out how to complete the task it has been given. The prescribed set of rules for accomplishing a distinct goal will allow the algorithm to learn and decide which steps to take along the way. This combination of rules along with positive and negative feedback would allow a reinforcement learning machine learning system to optimize the task over time.

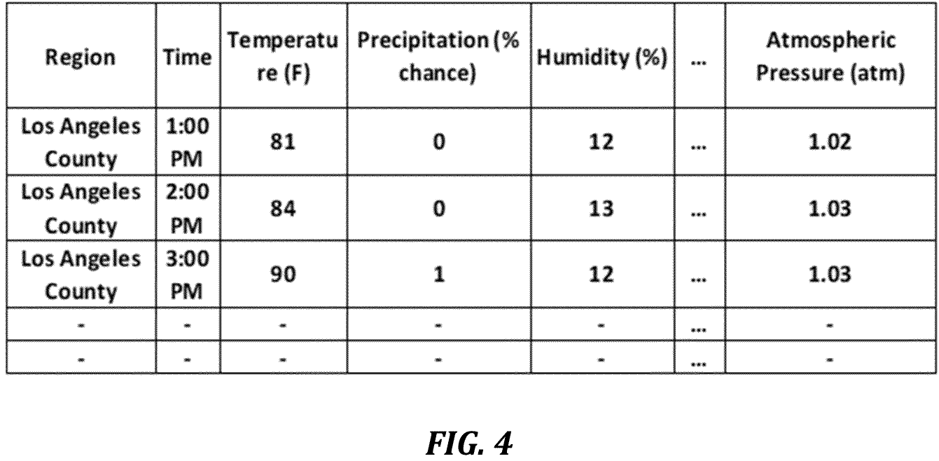

The Measurement Database 134 will now be explained with reference to FIG. 4.

FIG. 4 illustrates the measurement database 134. The measurement database 134 may contain historical, current, and/or predicted metrics for a region. The data stored in the measurement database 134 may be any data that may affect the parameters of a fluid tank (e.g., the fluid tank 102). For example, weather data (e.g., temperature) may be relevant to determining a rate of propane use from a propane tank, because propane may be used faster during cooler temperatures. Wildfire data may be relevant to determining when to refill a water tank. Human behavioral data may be relevant to determining what temperature fluid in a soda machine tank should be kept at, etc. FIG. 4 is an example of a measurement database 134 that contains weather data, but the system may use multiple databases with different datasets. Each of these datasets may be stored in a measurement database 134, or the measurement database 134 may refer to these datasets in the aggregate.

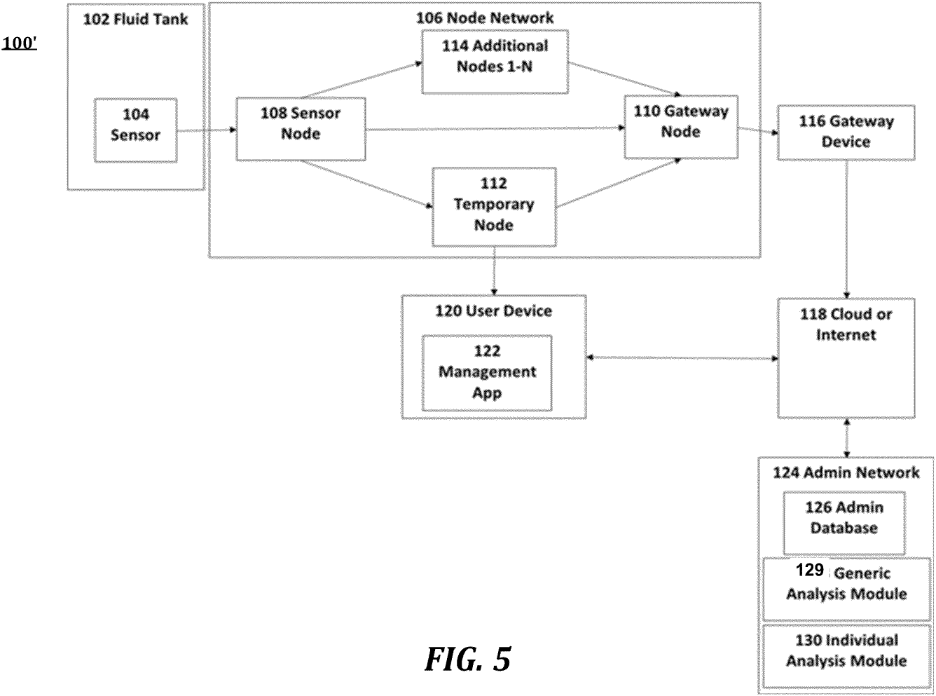

FIG. 5 shows another embodiment of the system 100′ for fluid tank management. This system includes a fluid tank 102, which may be any container that contains a fluid (e.g., a liquid or a gas). For example, a propane tank, an oxygen tank, a water bottle, a canister of liquid nitrogen, a bag of saline solution, a container of pressurized carbon dioxide, etc., are non-limiting examples of a fluid tank.

A sensor 104 may be a device that detects at least one property or parameter of the fluid tank 102, such as (but not limited to) fluid level, pressure, temperature, etc. For example, the sensor 104 may be a Hall effect sensor capable of detecting a fluid level in the tank 102 based on the movement of a magnet that is connected to a float inside the tank.

The sensor 104 may be connected to a gateway device 116 and/or a user device 120 by a network 106. In some embodiments, the network 106 may be formed as a node network, a hub and spoke network, or any other network architecture suitable for conveying data between the sensor 104 and the gateway device 116 and/or user device 120. In some embodiments, the network may include one or more additional devices, such as a repeater, a bridge, a router, a switch, and/or an extender. Data may be communicated between devices within the network using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to or from other nodes or other system elements, such as the sensor 104, the gateway device 116, or the user device 120. Each node may represent, for example, a communication endpoint and/or a redistribution point within the network. A node may be an electronic device attached to a network and capable of creating, receiving, or transmitting information. Nodes may be self-contained wireless communication devices that can communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc.

One or more of the nodes in the network 106 may be contained within other system elements such as the gateway device 116 and/or the sensor 104. In addition, one or more nodes may be contained in a housing, such as a plastic container containing space for the electronics that comprise the node. A node may refer to the electronics that perform the communications or refer to both the electronics and housing. The network 106 may be comprised of three nodes: a sensor node 108, which is fixed near or at the sensor 102; a gateway node 110, which is fixed near or at the gateway device 116; and a temporary node 112, which is mobile or otherwise temporary. In some embodiments, the network 106 may include additional nodes 114 to create a mesh network, a hub and spoke network, a linear topology network, or any other network topology for communicating data among the network nodes, and/or to provide additional network functionality. Some of the additional nodes may be alternate versions of the three nodes discussed above (e.g., the sensor node 108, the gateway node 110, and the temporary node 112).

For example, there may be two nodes that are fixed near the sensor 102, both of which may be sensor nodes 108 such that, if one node fails, the other node can still transmit data from the sensor 104 to other nodes on the network 106. In some embodiments, one or more additional nodes 114 may be intermediate nodes that neither receive data directly from the sensor 104 nor transmit data directly to the gateway device 116, but instead transfer data from one node to another to increase the range of the signal, ensure data integrity, or facilitate the integration of the temporary node 112 into the network 106.

A sensor node 108 may be a node that receives data from the sensor 104. Data may be transmitted to the sensor node 108 via a wired or wireless communication from the sensor 104. The sensor node 108 may be configured to read data from the sensor 104 if the sensor is analog or otherwise not configured to transmit measurement data. There may be more than one sensor node 108, which node is the sensor node 108 may change based on connection strength between the sensor and nodes in the network 106. The sensor node 108 may be connected to the sensor 104, which may detect a parameter, such as fluid level, of the fluid tank 102. For example, the sensor may read the position of the level gauge needle on the propane tank. The sensor node 108 may be attached to a support, which allows it to mount to the fluid tank 102 and/or the sensor 104. Due to the obstacles and/or obstructions, the sensor node 108 may not be able to communicate with the gateway node 110 directly. One or more additional nodes 114 may be placed in a location that allows it to relay wireless communications around obstacles and obstructions. In cases where there is little or no obstruction, the gateway node 110 and the sensor node 108 may be the same node.

A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap. This is the normal round trip of measurement data transmission and acknowledgment reception.

When the admin network 124 receives the data, it may log these data, run a trend analysis or other analysis, and/or initiate a service action. The service action may include routing a propane delivery to the fluid tank 102 in the system because the tank level is low, and one or more other logistical factors contribute to the conclusion to make such a delivery. Additionally or alternatively, the service action may include a network maintenance action, such as, if any of the nodes in the network 106 reported that its battery is low enough to require replacement, initiating a replacement action. The replacement action may include replacing the battery or replacing an entire node.

A temporary node 112 may be a node that temporarily connects to the network 106 to send and receive data from other nodes. This data may then be passed on to the gateway node 110 or other nodes in the network. These nodes may be mobile, such that one node could join multiple networks 106 based on proximity. The temporary node may be able to send data directly to the user device 120 when access to the cloud or internet 118 is unavailable. For example, a service technician may carry a temporary node 112 so that a user device may integrate with any network 106 and access data without connecting to the cloud or internet 118. The temporary node 112 may be a node that has augmented equipment allowing direct display of network parameters and command functions to the user. In this case, the user may be a service representative. Such a node may be required for network maintenance. For example, if the gateway mechanism is unavailable due to rendering the local RF network “invisible” to the remote system, the user device 120 may be used to perform network maintenance. If the gateway device 116 and internet connectivity is operational, an alternate method for the service person to use for performing maintenance would be accessing the network information via a user device 120 or a web page associated with the admin network 124 on an internet-connected device. The temporary node 112 may not be ported by the service person but by the delivery or service vehicle. Valuable data may be obtained by understanding when this temporary node may have joined a local network and how long it was present. If attached to a delivery vehicle, it may have its own measurement module(s) and may be able to provide data about the transfer from a tank on the vehicle to the fluid tank 102.

Zero or more additional nodes 114 may facilitate the communication of data within the network 106. For example, if the sensor node 108 is too far from the gateway node 110 to communicate, or there is an obstruction blocking communication, then additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem, or a router that sends data to a modem that sends data to the cloud or internet 118.

A cloud or internet 118, which may be a wired or a wireless network. The network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. At the same time, third-party clouds enable organizations to focus on their core businesses instead of expending resources on computer infrastructure and maintenance.

A user device 120 may be any device that can receive information from the cloud or internet 118 such as a laptop, smartphone, tablet, computer, or smart speaker. The user device 120 may also be a device that can receive or send information to one or more nodes on the network 106.

A management app 122 may be an application on the user device 120 that can display information related to the fluid tank 102. The information may be obtained from the admin network 124 or directly from the network 106. The management app 122 may also allow a user or service technician to affect elements of the system. As non-limiting examples, the management app 122 may be able to remotely drain the fluid tank 102, cut off the flow of fluid out of the fluid tank 102, reset the network 106, etc. The management app 122 may allow a user to receive information from and control the system. The user may be the owner or user of the fluid tank 102, a technician, an agent of a tank refilling company, a regulator, etc. The management app may receive data from the admin network 124 if a connection to the network is available. If a connection to the admin network 124 is unavailable, the management app 122 may connect directly to the network 106. Connection to the network 106 may require proximity to at least one node on the network. The node may be the temporary node 112, which may be part of or connected to the user device 120. For example, the user device may be a smartphone attached via USB-C cable to a temporary node 112. The temporary node 112 may sync up to a nearby network 106 such that the user device 120 can obtain information from the network 106 through the connection with the temporary node 112. The user device 120 and temporary node 112 may be the same device or may be housed in the same container. For example, a handheld tablet containing an RFID communication device that can receive data from the network 106 may serve as both the user device 120 and the temporary node 112. The management app 122 may display the data from the admin network 124 and/or the network 106 to the user. The user may be able to navigate through the management app 122 to view, format, and/or filter the data. The user may be able to make changes to the system using the management app 122. As non-limiting examples, the changes may include requesting early refueling, rebooting a node or the network 106, controlling which data is sent to the admin network 124, etc. Additional elements of the system may be controlled through the management app 122. For example, an emergency shut-off valve controlled remotely may be activated through the management app 122. Management may be automated through the management app 122. For example, when the fluid level in the fluid tank 102 begins to drop more rapidly than normal, an emergency shut-off valve may be activated without user intervention.

An admin network 124 may be a computer or network of computers that receives data related to the fluid tank 102 through the cloud or internet 118. This data may be stored, sent, altered, and/or used in programs or modules.

An admin database 126 may contain data received by the admin network 124. The admin database 126 may contain a record of all data related to the fluid tank 102 that has been received at the admin network 124 over time. The admin database 126 may contain data from multiple instances of this system. The admin database 126 may contain data from other sources, such as (but not limited to) weather data, fluid tank 102 manufacturer data, data provided by a system user, etc.

A generic analysis module 129 may analyze the data stored in the admin database and may adjust the received measurement data from the sensor 104 related to the fluid tank 102 based on historical data from similar sensors and/or fluid tanks. For example, if all fluid tanks 102 from the same manufacturer flare out at the bottom, the readings from the sensor 104 may need to be adjusted to reflect that lower fluid levels will last longer than expected.

An individual analysis module 130 may adjust the received measurement data from the sensor 104 related to the fluid tank 102 based on historical data from that particular sensor 104 and/or fluid tank 102. For example, if historical data shows that the fluid in the fluid tank 102 was empty when the sensor 104 reported a fluid level of 10%. The detected fluid level in the fluid tank 102 may be adjusted to reflect that 10% is when the fluid runs out instead of 0% as expected.

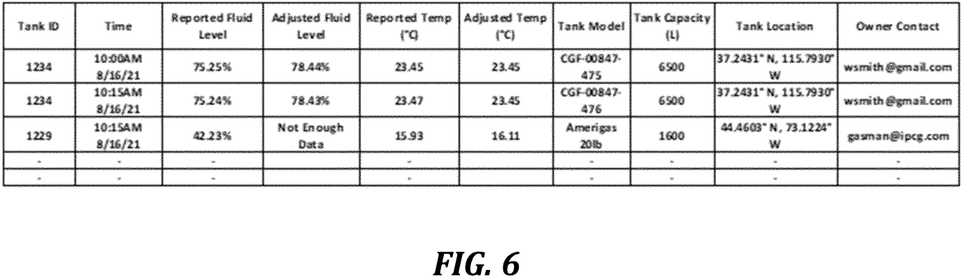

Another embodiment of the admin database 126 will now be explained with reference to FIG. 6.

FIG. 6 displays the admin database 126. The admin database 126 may contain identifying information for a fluid tank 102. For example, the identifying information may include a tank ID, a make or model of the tank 102, a location of the tank, and/or contact information for the owner or manager of the tank. The admin database 126 may contain data received related to the properties or parameters of the tank 102 from the sensor 104. For example, as shown in FIG. 6, the admin database 126 includes data about a reported fluid level of the fluid tank 102. This data may be timestamped to indicate a time at which the measurement was taken, and may be saved in the database continuously or at intervals (e.g., regular intervals such as every 5 minutes, every 15 minutes, every hour, etc., or irregular intervals based on measured, calculated, and/or anticipated usage). The admin database 126 may store data describing features of the tank 102 that may be useful in determining when the tank will need to be filled, such as (but not limited to) the total tank capacity. Some of this data may be obtained from sources outside the admin network 124, such as the manufacturer’s website. The admin database 126 may contain additional data received from the network 106, such as temperature or weather data. The admin database 126 may also contain the values of any parameter that has been adjusted based on data analysis done by the generic analysis module 129 or the individual analysis module 130.

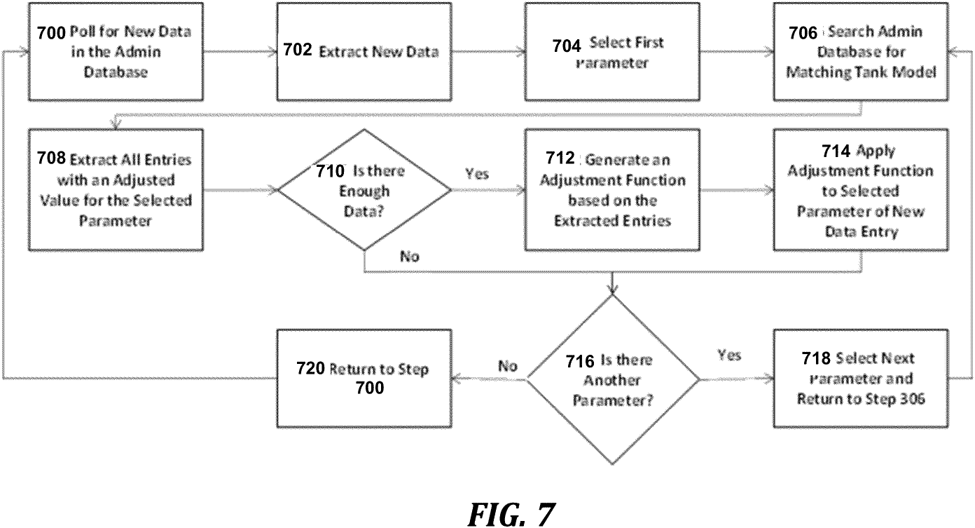

Functioning of the generic analysis module 129 will now be explained with reference to FIG. 7.

FIG. 7 displays the functioning of the generic analysis module 129. The process may begin at step 700, with the generic analysis module 129 polling for new data in the admin database 126. The new data may correspond to data that has just been received by the admin network 124, and may have originated at the sensor 104. The new data may correspond to data that was newly created and/or data that was updated. At step 702, the generic analysis module 129 may extract the new data from the admin database 126. At step 704, the generic analysis module 129 may select a first parameter from the extracted new data entry. For example, the reported fluid level of the fluid tank 102.

At step 706, the generic analysis module 129 may search the admin database 126 for entries that match the tank identified in the extracted new data entry. For example, the generic analysis module 129 may search for other tanks having a matching tank model number, a similar tank model number, a matching tank capacity, and/or the like. In some embodiments, the search may exclude entries that identify the specific tank reference in the extracted new data (e.g., entries with the same tank ID number). If available (e.g., if stored in the admin database 126), the search conducted by the generic analysis module 129 may include a matching sensor model instead of or in addition to the same tank.

At step 708, the generic analysis module 129 may extract all entries matching entries with an adjusted value for the selected parameter from the entries identified in step 706. As a non-limiting example, if the selected parameter is fluid level, the extracted data entries may include data entries from tanks having the same model as the new entry, which have an adjusted value for fluid level. This adjusted value may have been generated by the generic analysis module 129, the individual analysis module 130, another module, or any combination of modules.

At step 710, the generic analysis module 129 may determine if the number of extracted entries exceeds a threshold value. As a non-limiting example it may be determined if there are at least 100 extracted entries. As mentioned above, the threshold amount of data required for a meaningful adjustment may be different than 100. The threshold may be static or dynamic. The threshold may be set manually by an administrator of the system or automatically by another module.

If number of extracted entries meets or exceeds the threshold (YES in step 710), the generic analysis module 129 may, in step 712, generate an adjustment function for the selected parameter. In some embodiments, the adjustment function may be a static average adjustment. The generic analysis module 129 may calculate the average adjustment factor by dividing the adjusted value for the parameter by the originally reported value for each extracted entry and then averaging the results. For example, in a first entry, the adjusted value for fluid level is 55%, and the reported value is 50%, and in a second entry, the adjusted value for fluid level is 60%, and the reported value is 50%. The adjustment factor for the first entry is 55% divided by 50%, which is 110%, the adjustment factor for the second entry is 60% divided by 50%, which is 120%, and the average adjustment factor would be 115%. The adjustment function may dynamically change as the parameter changes.

In some embodiments, calculating the adjustment function may include calculating the slope and intercept of a best-fit line using regression analysis techniques from the adjusted values for the selected parameter from the extracted entries using simple linear regression. The input value of the function may be the reported value. For example, if one model of a fluid tank tends to be flared out at the bottom, then the function would reflect that as the fluid level in the fluid tank dropped, the reported level of fluid would be more inaccurate. High fluid levels of 100%-80% may not be adjusted at all or adjusted slightly, whereas low fluid levels such as 10%-20% may be adjusted to 20%-25% because the amount of fluid left in the tank is higher than expected due to the flared base of this fluid tank model. The best fit function may be logarithmic, polynomial, exponential, moving average, any other best fit function, or any combinations thereof. If there are inaccuracies known to the manufacturer of the fluid tank or sensor models, the known inaccuracies may be incorporated in the adjustment function.

At step 714, the generic analysis module 129 may apply the adjustment function created in step 712 to the reported value of a selected parameter of the new data. For example, if the selected parameter is tank fluid level, the reported value is 70%, and the adjustment function has an adjustment factor is 115%, then applying the adjustment factor to the reported value gives an adjusted value of 80.5%. This value may then be stored in the admin database 126 as part of the new data entry. In some embodiments, where the new data entry already has an adjusted value for the selected parameter (e.g., if the parameter has been adjusted by the individual analysis module 130), the newly generated adjusted value may replace the existing value, be stored in addition to the existing value, or be combined with the existing value.

Returning to step 710, if the number of extracted entries is less than the threshold value (NO in step 710), the generic analysis module 129 may store an indication in the admin database 126, such as the string “not enough data,” indicating insufficient data to create a meaningful adjustment function. And may advance to step 716.

Following application of the adjustment function, or if there is not enough data to create a meaningful adjustment function, the process may proceed to step 716, where the generic analysis module 129 may determine if another parameter in the new data has not yet been selected. For example, the temperature recorded at the tank. Different models of fluid tank and the properties of the fluid inside the fluid tank may cause temperature readings to be inaccurate. The placement of the temperature sensor may cause discrepancies between different tank models. For example, tanks with internal temperature sensors may report a different temperature than tanks with external temperature sensors under the same conditions. Data from external sensors may be adjusted to conform with the internal sensors so that all temperature data in the admin database 126 can be used by other modules as though it was internal temperature data.

If there is another parameter (YES, at step 716), the generic analysis module 129 may, in step 718, select a next parameter and return to step 706. If there are no other parameters (NO in step 716), the generic analysis module 129 may return to step 700.

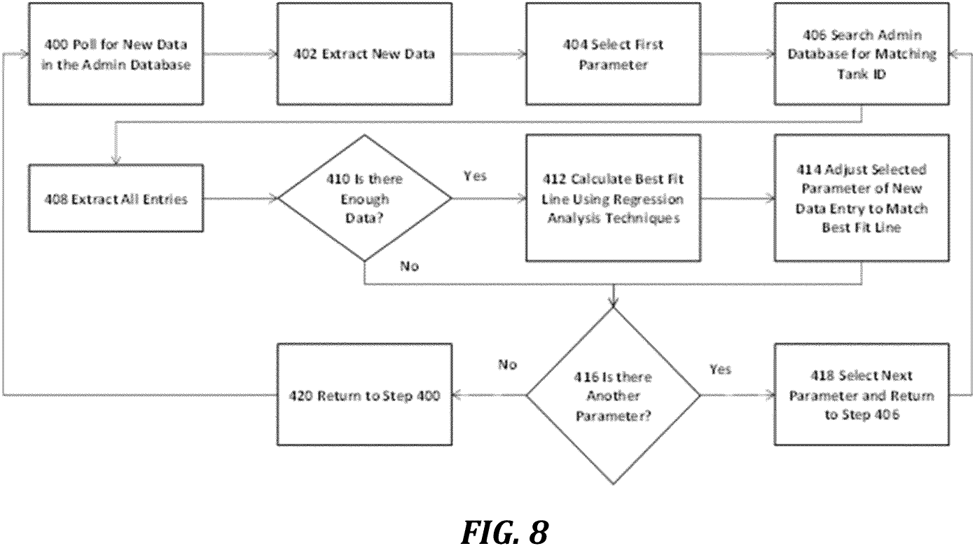

Functioning of the Individual Analysis Module 130 will now be explained with reference to FIG. 8.

FIG. 8 displays the functioning of the individual analysis module 130. The process may begin at step 400 with the individual analysis module 130 polling for new data in the admin database 126. The new data may correspond to data that has just been received by the admin network 124 (e.g., data that originated at the sensor 104). Additionally or alternatively, the new data may be data that was newly created or updated. At step 402, the individual analysis module 130 may extract the new data from the admin database 126. At step 404, the individual analysis module 130 may select the first parameter from the new data entry, such as (but not limited to) the fluid tank 102′s reported fluid level.

At step 406, the individual analysis module 130 may search the admin database 126 for entries associated with the same tank as the extracted new entry. For example, the entries may be deemed to match if the tank ID of the entry matches the tank ID of the extracted new entry. The data found by the individual data analysis module 130 may correspond to all historical data from the same fluid tank 102 stored in the admin database 126. The individual analysis module 130 may extract one or more (e.g., all) of the entries that are deemed to match the extracted new entry and include a reported value for the selected parameter at step 408.

At step 410, the individual analysis module 130 may determine if there are at least a threshold number of extracted entries. As a particular example, the threshold may be 100 extracted entries. The threshold number of extracted entries may correspond to an amount of data required to create a meaningful adjustment function. In some embodiments, the threshold number of entries may be different than 100. The threshold may be static or dynamic. The threshold may be set manually by an administrator of the system or automatically by another module at step 410.

If there are at least the threshold number of extracted entries (YES in step 410), the individual analysis module 130 may, in step 412, calculate a best-fit function using regression analysis techniques from the historical data for the selected parameter from the extracted entries using simple linear regression. The best fit function may be logarithmic, polynomial, exponential, moving average, any other best fit function, or any combination thereof. Other functions may be used for predictive analysis or calibration. The function or functions used may be based on the parameter. For example, the fluid level in a water tank would not be expected to rise if the fluid is only being drained, so a ceiling function may be used to adjust downward any values that are higher than a previously reported value.

At step 414, the individual analysis module 130 may adjust the selected parameter of the new data entry to match the best fit line. For example, extrapolation of the best fit line from the most recent historical data estimates a fluid level value of 71.4%. The reported value for the fluid level in the new data is 68%. The reported value may be adjusted to be closer to 71.4% or equal to 71.4%. This value may then be stored in the admin database 126 as part of the new data entry. In some embodiments, if the new data entry already has an adjusted value for the selected parameter (e.g., generated by the generic analysis module 129), the newly generated adjusted value may replace the existing value, be stored in addition to the existing value, or be combined with the existing value.

Returning now to step 410, if there are less than the threshold number of extracted entries (NO in step 410), the individual analysis module 130 may store an indication in the admin database 126, such as the string “not enough data,” indicating insufficient data to make a meaningful adjustment. Thereafter, the process may proceed to step 416.

After adjusting the parameter in step 414, or after determining in step 410 that not enough data is present, the individual analysis module 130 may determine if another parameter in the extracted new data entry has not yet been selected, in step 416. For example, the temperature recorded at the tank. Different fluid tanks 102 and the properties of the fluid inside the fluid tank 102 may cause temperature readings to be inaccurate. Temperature sensors 104 exposed to outside elements, such as direct sunlight, may be inaccurate at some times on some days.

If there is another parameter (YES at step 416), the individual analysis module 130 may select the next parameter at step 418. Thereafter, the process may return to step 406. If there are no other parameters (NO at step 416), the individual analysis module 130 may return to step 400, at step 420.

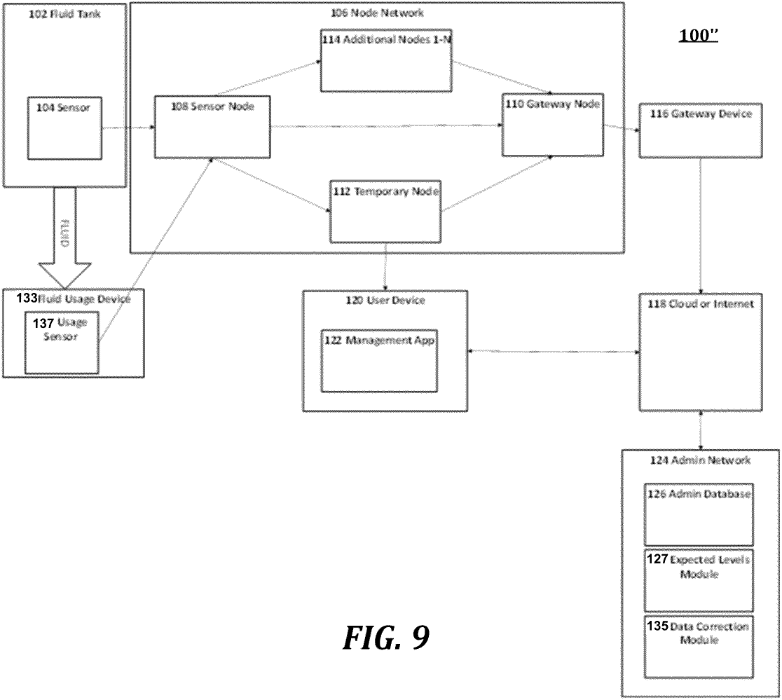

FIG. 9 shows another embodiment of a system 100″ for fluid tank management. This system includes a fluid tank 102, which may be any container containing a fluid, such as a propane tank, an oxygen tank, a water bottle, a canister of liquid nitrogen, a bag of saline solution, and a container of pressurized carbon dioxide, etc.

A sensor 104 may be a device that detects at least one property or parameter of the fluid tank 102 such as, but not limited to, fluid level, pressure, temperature, etc. As a particular example, the sensor 104 may include a Hall effect sensor for detecting a fluid level in the fluid tank 102 based on the movement of a magnet that is connected to a float inside a fluid tank.

The sensor 104 may be connected to a gateway device 116 and/or a user device 124 by a network 106. In some embodiments, the network 106 may be formed as a node network, a hub and spoke network, or any other network architecture suitable for conveying data between the sensor 104 and the gateway device 116 and/or user device 120. In some embodiments, the network may include one or more additional devices, such as a repeater, a bridge, a router, a switch, and/or an extender. Data may be communicated between devices within the network 106 using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to or from other nodes or other system elements, such as the sensor 104, the gateway device 116, or the user device 120. Each node may represent, for example, a communication endpoint and/or a redistribution point within the network.

A node may be an electronic device attached to a network capable of creating, receiving, and/or transmitting information. Nodes may be self-contained wireless communication devices that can communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc. One or more of the nodes in the network 106 may be contained within other system elements such as the gateway device 116 or sensor 104. In addition, nodes may be contained in a housing, such as a plastic container containing space for the electronics that comprise the node. A node may refer to the electronics that perform the communications or refer to both the electronics and housing. The network 106 may be comprised of three nodes: a sensor node 108, which is fixed near or at the sensor 102; a gateway node 110, which is fixed near or at the gateway device 116; and a temporary node 112, which is mobile or otherwise temporary. In some embodiments, the network may include additional nodes 114 to create a mesh network, a hub and spoke network, a linear topology network, or any other network topology for communicating data among the network nodes, and/or to provide additional network functionality.

Some of the additional nodes may be alternate versions of the three nodes discussed above (e.g., the sensor node 108, the gateway node 110, and/or the temporary node 112). For example, there may be two nodes that are fixed near the sensor 102, both of which may be sensor nodes 108 such that if one node fails, the other node can still transmit data from the sensor 104 to other nodes on the network 106. Additional nodes 114 may also be intermediate nodes that neither receive data directly from the sensor 104 nor transmit data directly to the gateway device 116, but instead transfer data from one node to another to increase the range of the signal, ensure data integrity, or facilitate the integration of the temporary node 112 into the network 106.

A sensor node 108 may be a node that receives data from the sensor 104. Data may be transmitted to the node via wired or wireless communication from the sensor 104. The sensor node 108 may be configured to read data from the sensor if the sensor is analog or otherwise not capable of transmitting data. There may be more than one sensor node 108, and which node is the sensor node 108 may change based on (as a non-limiting example) connection strength between the sensor and nodes in the network 106. The sensor node 108 may be connected to the sensor 104, which may detect a parameter, such as fluid level, of the fluid tank 102. For example, the sensor may read the position of the level gauge needle on the propane tank. The sensor node 108 may be attached to a support, which allows it to mount to the fluid tank 102 or the sensor 104. Due to obstacles and/or obstructions, the sensor node 108 may not directly communicate with the gateway node 110. Instead, one or more additional nodes 114 may be placed in a location that allows it to relay wireless communications around obstacles and obstructions. In cases where there is little or no obstruction, the gateway node 110 and the sensor node 108 may be the same node.

A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap. This is the normal round trip of measurement data transmission and acknowledgment reception. When the admin network 124 receives the data, it may simply log these data, run a trend analysis or other analysis, and may initiate a service action. Such action may be as routing as a propane delivery because the tank level is low, and other logistical factors contribute to the conclusion to make such delivery. Alternatively, the service action may be more along the lines of network maintenance, such as if any of the nodes in the network 106 reported that its battery is low enough to require replacement. Such replacement may be of the battery or may be of an entire node.

A temporary node 112 may be a node that temporarily connects to the network 106 to send and receive data from other nodes. This data may be passed on to the gateway node 110 or other nodes in the network 106. The temporary node 112 may be mobile, such that one node could join multiple networks 106 based on proximity. The temporary node 112 may be able to send data directly to the user device 120 when access to the cloud or internet 118 is unavailable. For example, a service technician may carry a temporary node 112 to integrate with any network 106 and access data without connecting to the cloud or internet 118. The temporary node 112 may be a node that has augmented equipment allowing direct display of network parameters and command functions to the user. In this case, the user may be a service representative. The temporary node 112 may be useful for network maintenance, especially if the gateway device 116 is unavailable, rendering the local RF network “invisible” to the remote system. If the gateway device 116 and internet connectivity is operational, an alternate method for the service person to use would be accessing the network information via a user device 120 or a web page associated with the admin network 124 on an internet-connected device. The temporary node 112 may not be ported by the service person but by the delivery or service vehicle. Valuable data may be obtained by understanding when this temporary node may have joined a local network and how long it was present. If attached to a delivery vehicle, the temporary node 112 may have its own measurement module(s) and may be able to provide data about the transfer from a tank on the vehicle to the fluid tank 102.

Zero or more additional nodes 114 may facilitate the communication of data within the network 106. For example, if the sensor node 108 is too far from the gateway node 110 to communicate, or there is an obstruction blocking communication, then one or more additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem, or may be a router that sends data to a modem that sends data to the cloud or internet 118.

A cloud or internet 118 may be a wired or a wireless network. The network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. At the same time, third-party clouds enable organizations to focus on their core businesses instead of expending resources on computer infrastructure and maintenance.

A user device 120 may be any device that can receive information from the cloud or internet 118 such as a laptop, smartphone, tablet, computer, or smart speaker. The user device 120 may also be a device that can receive or send information to one or more nodes on the network 106.

A management app 122 may be an application on the user device 120 that can display information related to the fluid tank 102 obtained from the admin network 124 or directly from the network 106. The management app 122 may also allow a user or service technician to affect elements of the system. For example, the management app 122 may be able to remotely drain the fluid tank 102, cut off the flow of fluid out of the fluid tank 102, reset the network 106, etc. The management app 122 may allow a user to receive information from and control the system. The user may be the owner or user of the fluid tank 102, a technician, an agent of a tank refilling company, a regulator, etc. The management app 122 may receive data from the admin network 124 if a connection to the network is available. If a connection to the admin network 124 is unavailable, the management app 122 may connect directly to the network 106. Connection to the network 106 may require proximity to at least one node on the network. This node may be the temporary node 112, which may be part of or connected to the user device 120. For example, the user device 120 may be a smartphone attached via USB-C cable to a temporary node 112. The temporary node 112 may sync up to a nearby network 106 such that the user device 120 can obtain information from the network 106 through the connection with the temporary node 112. The user device 120 and the temporary node 112 may be the same device or may be housed in the same container. For example, a handheld tablet containing an RFID communication device can receive data from the network 106, and may serve as both the user device 120 and the temporary node 112. The management app 122 may display the data from the admin network 124 and/or network 106 to the user.

The user may navigate through the management app 122 to view, format, and/or filter the data. The user may be able to change the system using the management app 122. As a non-limiting example, the user may request early refueling, reboot a node or the network 106, control which data is sent to the admin network 124, etc. Additional elements of the system may also be controlled through the management app 122. For example, an emergency shut-off valve controlled remotely may be activated through the management app 122. Management may be automated through the management app 122. For example, when the fluid level in the fluid tank 102 begins to drop more rapidly than normal, an emergency shut-off valve may be activated without user intervention.

An admin network 124 may be a computer or network of computers that receives data related to the fluid tank 102 through the cloud or internet 118. This data may be stored, sent, altered, and/or used in programs or modules. An admin database 126 may contain data received by the admin network 124. The admin database 126 may contain a record of all data related to the fluid tank 102 received over time. The admin database 126 may contain data from multiple instances of this system. The admin database 126 may also contain data from other sources such as, but not limited to, weather data, fluid tank 102 manufacturer data, data provided by a user of the system, etc.

An expected levels module 127 may predict the fluid level in the fluid tank 102 based on data from one or more fluid usage devices 133. For example, if a heater was using one gallon of propane per hour and a stove was using one gallon of propane per hour, then the expected level of propane in a propane tank would drop by two gallons per hour.

A data correction module 135 compares the predicted fluid level in the fluid tank 102 from the expected levels module 127 to the fluid levels received from the sensor 104. If there is a discrepancy, the data correction module 135 may store the discrepancy in the admin database 126. These discrepancies over time may be used to correct inaccuracies in the sensor 104, inaccuracies in the usage sensor 137, or potential leaks in the fluid tank 102 or elsewhere in the system.

A fluid usage device 133 may be any device that uses the fluid stored in the fluid tank 102. For example, a heater, a stove, a refrigerator, a pump, a reaction chamber, a hose, etc. Fluid usage may not necessarily consume the fluid. For example, a cooling device may keep the fluid within a temperature range and may remove some fluid from the fluid tank 102 but replace that fluid immediately or eventually.

A usage sensor 137 may be a device that detects the amount of fluid being used by the fluid usage device 133. For example, a usage sensor 137 may be a gas detector detecting when propane gas or the gases released when burning propane are released from a stovetop burner. The usage sensor 137 may not be able to detect the amount of fluid used by the fluid usage device 133 directly, but may instead detect if the device is in use. The usage sensor 137 may connect to the sensor node 108, an additional node 114, or may connect to the admin network 124 through other means.

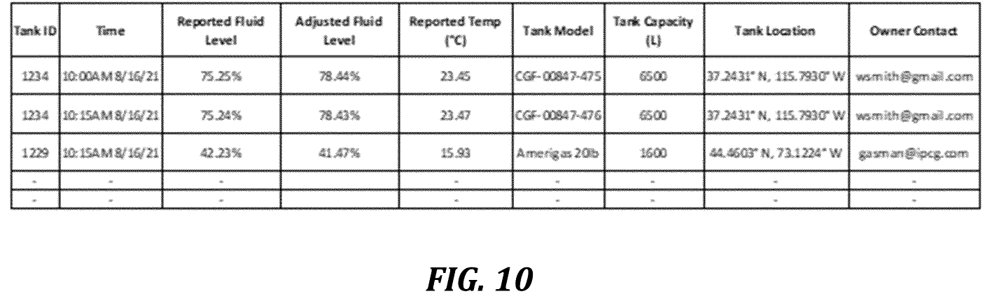

Another embodiment of the admin database 126 will now be explained with reference to FIG. 10.

FIG. 10 displays the admin database 126. The admin database 126 may contain identifying information for a fluid tank 102. For example, a tank ID, the make or model of the tank, the location of the tank, and/or contact information for the owner or manager of the tank. The admin database 126 may also contain the data received about the fluid level of the fluid tank 102. This data may be timestamped and may be saved in the database continuously, at regular intervals, such as (but not limited to) every 5 minutes, every 15 minutes, every hour, etc., or at irregular intervals based on measured, calculated, and/or anticipated usage. The admin database 126 may contain features of the tank that would be useful in determining when the tank will need to be filled, such as (but not limited to) the total tank capacity. Some of this data, such as tank capacity, may be obtained from sources outside the admin network 124, such as the manufacturer’s website. The admin database 126 may contain additional data from the network 106, such as temperature or weather data. The admin database 126 may contain adjusted parameters that are different from the reported parameters. These parameters may be adjusted by the data correction module 130 based on discrepancies between the reported parameter value and the expected value based on data from the fluid usage device 133.

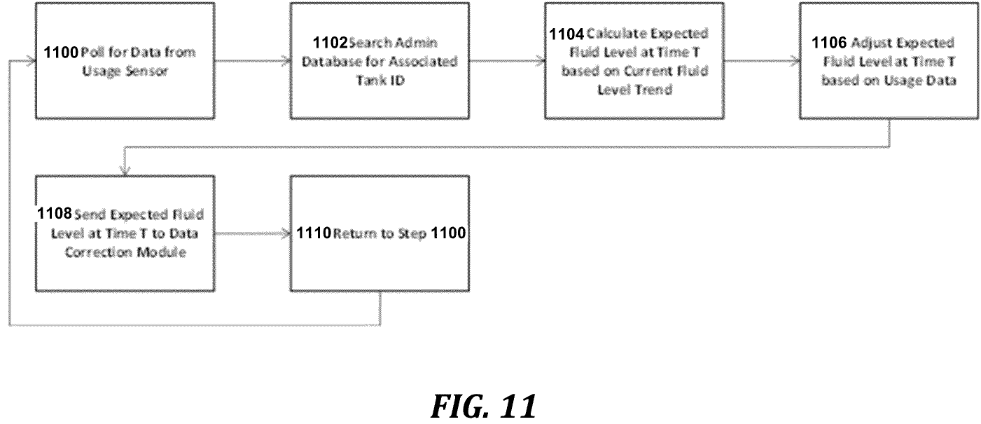

Functioning of the Expected Levels Module 127 will now be explained with reference to FIG. 11.

FIG. 11 displays the functioning of an expected levels module. In particular, the functioning of the expected levels module is explained with regard to the expected levels module 127, as shown in FIG. 9. The process may begin at step 1100 with the expected levels module polling for data from a usage sensor (e.g., the usage sensor 137 of FIG. 9). Data from the usage sensor may be a binary on/off signal indicating the state of a fluid usage device (e.g., the fluid usage device 133 of FIG. 9), or may contain data relevant to the amount of fluid usage, such as (but not limited to) fluid usage per unit time, absolute fluid usage, and/or which state the fluid usage device is in if there are multiple states (e.g., the temperature an oven is set to). Data from the usage sensor may contain an associated tank ID.

At step 1102, the expected levels module may search an admin database e.g., the admin database 126 of FIG. 9) for an identifier associated with the usage sensor and/or the fluid usage device. The identifier (e.g., a tank ID) may be contained in the data from the usage sensor and/or determined based on the data from both the usage sensor and sensor being routed through the same network or gateway device.

The expected levels module may calculate an expected fluid level at time T based on the admin database search results in step 1104. The time T may be any time in the future. The current fluid level of the tank may be obtained from the most recent entry. Previous entries for the same tank may be used to estimate a future trend.

For example, if the fluid level of a fluid tank has been decreasing at a consistent rate of 1 L per hour, the estimated future trend may also be 1 L per hour. This estimate may be based on a best fit line of a subset of fluid level data, such as the last hour, last 10 minutes, last 1 minute, last 100 entries, etc., which subset of data is used for this estimate may be static or dynamic and may be set by an administrator of the system or another module.

At step 1106, the expected levels module may adjust the expected fluid level at time T based on data from the usage sensor. For example, if time T is 10 minutes from the last reported fluid level. The reported fluid level is 800 L, falling at 1 L every 10 minutes. The expected fluid level at time T based on the current trend is 799 L. If data from the usage sensor shows that a fluid usage device, for example, a gas heater, has been turned on. The fluid usage device was not already on and is not included in the current trend of fluid loss. As an example, the newly turned-on fluid usage device is known to use 3 L every 10 minutes. Unless the fluid usage device is turned off, 4 L of fluid would be expected to be used in the next 10 minutes. The adjusted expected fluid level at time T would then be 796 L. If the fluid usage device is already on, then the expected fluid level at time T would not be adjusted unless data from the usage sensor indicates that the amount of fluid used by the fluid usage device has changed.

The expected levels module may send the expected fluid levels at time T to a data correction module (e.g., the data correction module 135 in FIG. 9) in step 1108. The expected levels module may also send time T to the data correction module.

At step 1110, the expected levels module may return to step 1100.

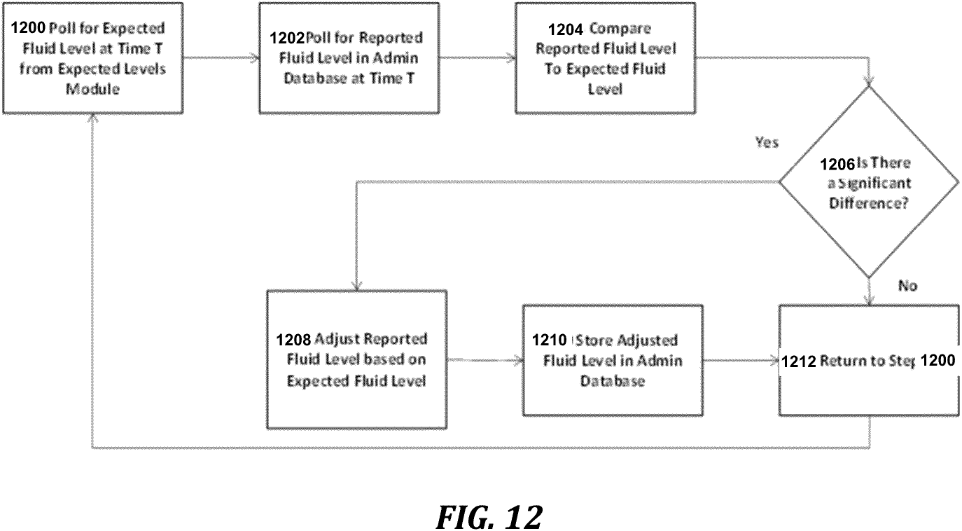

Functioning of the Data Correction Module 135 will now be explained with reference to FIG. 12.

FIG. 12 displays the functioning of the data correction module 135. The process may begin at step 1200 with the data correction module 135 polling for an expected fluid level at time T from the expected levels module 127. The data correction module 135 may also receive a time T or use a default value for time T. At step 1202, the data correction module 135 may poll for a reported fluid level in the admin database 126 at time T. If there is no reported fluid level at exactly time T, the data correction module 135 may poll for the earliest reported fluid level after time T, the latest, reported fluid level prior to time T, or the fluid level reported at a time nearest to time T. For example, if time T is 1:00:00.00 AM, but there is no reported fluid level at that time, then the next reported fluid level at 1:00:00.50 AM may be used instead.

The data correction module 135 may compare the reported fluid level at time T to the expected fluid level at time T in step 1204. This comparison may be made by subtracting one value from the other, dividing one value by the other, or any other known mathematical or logical comparison of the values. For example, if the reported fluid level is 75% and the expected is 73%, the difference may be 2%. In step 1206, the data correction module 135 may determine if there is a difference between the two values of more than a threshold fluid. The threshold value may be set such that a difference in the fluid level of more than the threshold value is considered a significant difference (e.g., to the owner or operator of the tank). As a particular example, the threshold value may be 0.1% of the fluid tank capacity. The threshold for significance may be based on fluid tank capacity, may be a flat value such as 0.1 L, may be dependent on the ratio between the expected and reported values, or may be some combination of these thresholds. The threshold may be static or dynamic and may be set by an administrator, a user of the system, or another module. Multiple significance thresholds may be set and may trigger different responses by the data correction module 135 or another module in the system. For example, if the expected fluid level is 20% greater than the reported fluid level, it may indicate a leak in the system, triggering an emergency shut-off valve, a notification, a leak verification process, etc.

If the difference between the two values is not significant (NO in step 1206), the data correction module 135 may skip to step 1212, where the process may return to step 1200.

If there is a difference between the two values (YES at step 1206), the data correction module 135 may adjust the reported fluid level based on the expected fluid level in step 1208. The adjusted fluid level may be set to be equal to the expected fluid level, or may be set to some value between the reported fluid level and the expected fluid level. For example, if the reported fluid level is 75% and the expected fluid level is 73%, then the adjusted fluid level may be set to 74%, 73%, 73.5%, 74.2%, etc. The data correction module 135 may store the adjusted fluid level in the admin database 126, at step 1210. The process may then proceed to step 1212, where the data correction module 135 may return to step 1200.

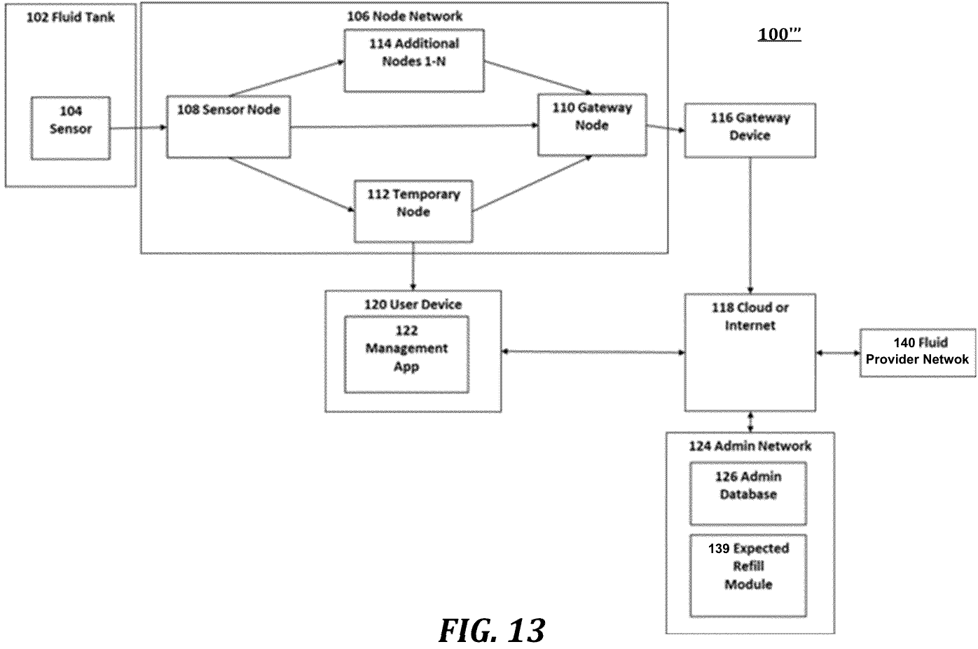

FIG. 13 shows yet another embodiment of a system 100‴ for fluid tank management. This system includes a fluid tank 102, which may be any container that contains a fluid. For example, a propane tank, an oxygen tank, a water bottle, a canister of liquid nitrogen, a bag of saline solution, a container of pressurized carbon dioxide, etc. A sensor 104 may be a device that detects at least one property or parameter of the fluid tank 102, such as fluid level, pressure, temperature, etc. For example, the sensor 104 may be a Hall effect sensor configured to detect a fluid level of the tank 102 based on the movement of a magnet that is connected to a float inside the tank. The sensor 104 may be connected to a gateway device 116 and/or a user device 124 by a network 106.

In some embodiments, the network 106 may be formed as a node network, a hub and spoke network, or any other network architecture suitable for conveying data between the sensor 104 and the gateway device 116 and/or user device 124. In some embodiments, the network 106 may include one or more additional devices, such as a repeater, a bridge, a router, a switch, and/or an extender. Data may be communicated between devices within the network 106 using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to or from other nodes or other system elements such as the sensor 104, the gateway device 116, or the user device 124. Each node may represent, for example, a communication endpoint and/or a redistribution point within the network.

A node may be an electronic device attached to a network and capable of creating, receiving, and/or transmitting information. Nodes may be self-contained wireless communication devices that can communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc. The nodes in the network 106 may be contained within other system elements such as the gateway device 116 or sensor 104. Nodes may be contained in a housing, such as a plastic container containing space for the electronics that comprise the node. A node may refer to the electronics that perform the communications or refer to both the electronics and housing. The network 106 may be comprised of three nodes: a sensor node 108, which is fixed near or at the sensor 102; a gateway node 110, which is fixed near or at the gateway device 116; and a temporary node 112, which is mobile or otherwise temporary. In some embodiments, the network 106 may include additional nodes 114 to create a mesh network, a hub and spoke network, a linear topology network, or any other network topology for communicating data among the network nodes, and/or to provide additional network functionality. At least some of the additional nodes 114 may be alternate versions of the three nodes discussed above (e.g., the sensor node 108, the gateway node 110, and the temporary node 112). For example, there may be two nodes that are fixed near the sensor 102, both of which may be sensor nodes 108 such that if one node fails, the other node can still transmit data from the sensor 104 to other nodes on the network 106. Additional nodes 114 may operate as intermediate nodes that neither receive data directly from the sensor 104 nor transmit data directly to the gateway device 116, but instead transfer data from one node to another to increase the range of the signal, ensure data integrity, or facilitate the integration of the temporary node 112 into the network 106.

A sensor node 108 may be a node that receives data from the sensor 104. Data may be transmitted to the node via wired or wireless communication from the sensor 104. The sensor node 108 may be configured to read data from the sensor if the sensor is analog or otherwise not configured to transmit data. There may be more than one sensor node 108, which node is the sensor node 108 may change based on connection strength between the sensor and nodes in the network 106. The sensor node 108 may be connected to the sensor 104, which may detect a property or parameter, such as fluid level, of the fluid tank 102. For example, the sensor 104 may read the position of the level gauge needle on the propane tank 102. The sensor node 108 may be attached to a support, which allows it to mount to the fluid tank 102 and/or the sensor 104. Due to the obstacles and/or obstructions, the sensor node 108 may not be able to communicate with the gateway node 110 directly. One or more additional nodes 114 may be placed in a location that allows the one or more additional nodes to relay wireless communications around obstacles and obstructions.

In cases where there is little or no obstruction, the gateway node 110 and the sensor node 108 may be the same node. A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap. This is the normal round trip of measurement data transmission and acknowledgment reception.

When the admin network 124 receives the data, it may log these data, run a trend analysis or other analysis, and/or initiate a service action. As one non-limiting example, the service action may be scheduling a propane delivery because the tank level is low, and other logistical factors contribute to the conclusion to make such delivery. Additionally or alternatively, the service action may be a network maintenance action, such as (but not limited to) a replacement action if any of the nodes in the network 106 reported that its battery is low enough to require replacement. Such replacement may be of the battery or may be of an entire node.

A temporary node 112 may be a node that temporarily connects to the network 106 to send and receive data from other nodes. This data may then be passed on to the gateway node 110 or other nodes in the network. These nodes may be mobile, such that one node could join multiple networks 106 based on proximity. The temporary node may send data directly to the user device 120 when access to the cloud or internet 118 is unavailable. For example, a service technician may carry a temporary node 112 to integrate with any network 106 and access data without being connected to the cloud or internet 118. The temporary node 112 may be a node that has augmented equipment allowing direct display of network parameters and command functions to the user. In this case, the user may be a service representative. Such a node may be useful for network maintenance, especially if the gateway mechanism is unavailable, rendering the local RF network “invisible” to the remote system. If the gateway device 116 and internet connectivity is operational, an alternate method for the service person to use would be accessing the network information via a user device 120 or a web page associated with the admin network 124 on an internet-connected device. The temporary node 112 may not be ported by the service person but instead the delivery or service vehicle. Valuable data may be obtained by understanding when this temporary node may have joined a local network and how long it was present. If attached to a delivery vehicle, the temporary node 112 may include one or more measurement module(s) and may be able to provide data about the transfer from a tank on the vehicle to the fluid tank 102.

Zero or more additional nodes 114 may facilitate the communication of data within the network 106. For example, if the sensor node 108 is too far from the gateway node 110 to communicate, or there is an obstruction blocking communication, then additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem, or a router that sends data to a modem that sends data to the cloud or internet 118.

A cloud or internet 118, which may be a wired or a wireless network. The network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. At the same time, third-party clouds enable organizations to focus on their core businesses instead of expending resources on computer infrastructure and maintenance. A user device 120 may be any device that can receive information from the cloud or internet 118 such as a laptop, smartphone, tablet, computer, or smart speaker. The user device 120 may also be a device that can receive or send information to one or more nodes on the network 106.

A management app 122 may be an application on the user device 120 that can display information related to the fluid tank 102 obtained from the admin network 124 or directly from the network 106. The management app 122 may allow a user or service technician to affect elements of the system. For example, the management app 122 may be able to remotely drain the fluid tank 102, cut off the flow of fluid out of the fluid tank 102, reset the network 106, etc. The management app 122 may allow a user to receive information from and control the system. The user may be the owner or user of the fluid tank 102, a technician, an agent of a tank refilling company, a regulator, etc. The management app 122 may receive data from the admin network 124 if a connection to the network is available. If a connection to the admin network 124 is unavailable, the management app 122 may connect directly to the network 106. Connection to the network 106 may require proximity to at least one node on the network. This node may be the temporary node 112, which may be part of or connected to the user device 120.

For example, the user device may be a smartphone attached via USB-C cable to a temporary node 112. The temporary node 112 may communicate with a nearby network 106 such that the user device 120 can obtain information from the network 106 through the connection with the temporary node 112. The user device 120 and temporary node 112 may be the same device or may be housed in the same container. For example, a handheld tablet containing an RFID communication device that can receive data from the network 106 may serve as both the user device 120 and the temporary node 112. The management app 122 may display the data from the admin network 124 or node network 106 to the user. The user may be able to navigate through the management app 122 to view, format, and/or filter the data. The user may be able to make changes to the system using the management app 122, for example (but not limited to), requesting early refueling, rebooting a node or the node network 106, controlling which data is sent to the admin network 124, etc. Additional elements of the system may also be controlled through the management app 122. For example, an emergency shut-off valve controlled remotely may be activated through the management app 122. In some embodiments, management may be automated through the management app 122. For example, when the fluid level in the fluid tank 102 begins to drop more rapidly than normal, an emergency shut-off valve may be activated without user intervention.

An admin network 124 may be a computer or network of computers that receives data on the fluid tank 102 through the cloud or internet 118. This data may be stored, sent, altered, and/or used in programs or modules. An admin database 126 may contain data received by the admin network 124. The admin database 126 may contain a record of all data received on the fluid tank 102 over time. The admin database 126 may contain data from multiple instances of the system. The admin database 126 may contain data from other sources such as, but not limited to, weather data, fluid tank 102 manufacturer data, data provided by a user of the system, etc. An expected refill module 139, which may determine, based at least in part on the known fluid capacity of the fluid tank 102, a current fluid level from the sensor 104, and one or more current and future parameters, an expected date and/or time when the fluid tank 102 will need to be refilled. The expected refill date may then be sent to the fluid provider network 140. If any circumstances may affect the expected refill date, those circumstances may be sent to the fluid provider network 140.

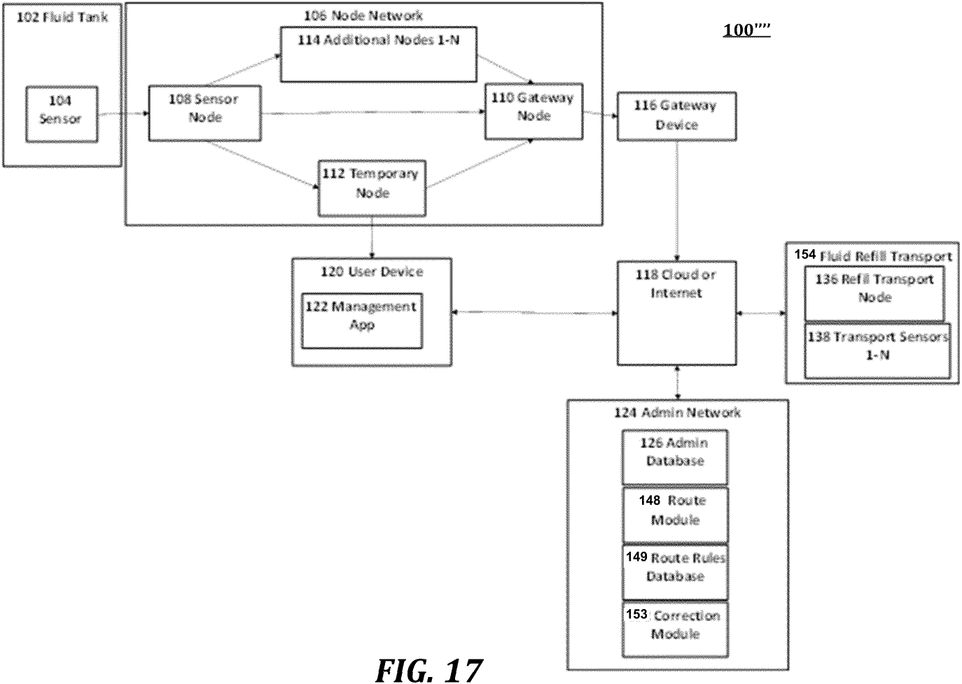

The fluid provider network 140 may be a computer or network of computers controlled or otherwise used by the provider of the fluid in the fluid tank 102. The fluid provider network 140 may collect data from the admin network 126, the user device 120, and/or the gateway device 116. In embodiments, the collected information may be used to schedule refilling or replacing the fluid in the fluid tank 102. The fluid provider network 140 may consider circumstances that may cause the expected refill to change, such as upcoming weather events, upcoming holidays, possible leaks, etc. The fluid provider network 140 may include one or more modules that assist with scheduling and delivery of the fluid. A fluid refill transport may transport fluid to the fluid tank 102 and facilitate the refill of the fluid tank 102. The refill fluid transport may be a vehicle capable of transporting fluid such as (but not limited to) a propane truck, a van carrying water tanks, a drone carrying liquid medicine, etc. The refill fluid transport (discussed in detail below with respect to FIG. 17) may communicate with the fluid provider network 140 to send and/or receive updates on the status of the fluid refill transport or the fluid tank 102 being refilled. A refill transport node may be attached to or associated with the fluid refill transport 132.

The refill transport node may be a temporary node 112. The refill transport node may collect information directly from the node network 106 associated with the fluid tank 102 being refilled by the fluid refill transport. The collected data may be used to conduct the refill and/or may be transmitted to the fluid provider network. If the fluid refill transport has no direct connection with the fluid provider network, the refill transport node can be used to send or receive data over the cloud or internet 118 by integrating with the local node network 106. Additionally or alternatively, the refill transport node may be able to cache data in a short-term database to be uploaded to the fluid provider network when access is available.

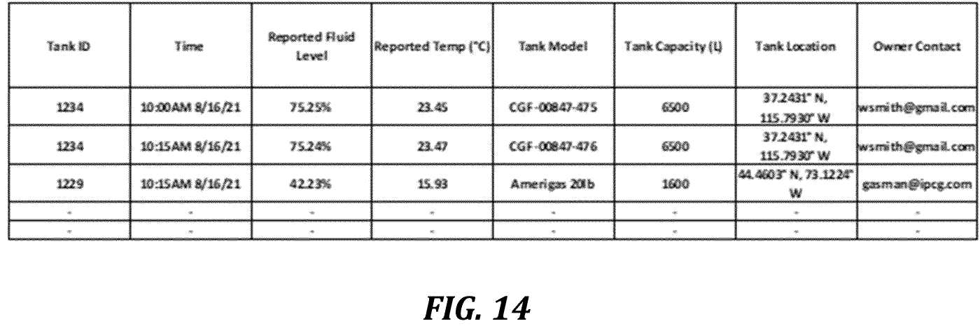

Another embodiment of the admin database 126 will now be explained with reference to FIG. 14.

FIG. 14 displays an embodiment of the admin database 126. The admin database 126 may contain identifying information for a fluid tank 102. For example, the identifying information may include one or more of a tank ID, the make or model of the tank, the location of the tank, and contact information for the owner or manager of a tank. The admin database 126 may contain the data received about the fluid level of the fluid tank 102. This data may be timestamped. In embodiments, the data may be saved in the database 126 continuously or at intervals, such as regular intervals (e.g., every 5 minutes, every 15 minutes, every hour, etc.) or irregular intervals (e.g., based on measured, calculated, and/or anticipated usage). The admin database 126 may contain features of the tank that would be useful in determining when the tank will need to be filled, such as, but not limited to, the total tank capacity. Some data, such as tank capacity, may be obtained from sources outside the admin network 124, such as the manufacturer’s website. The admin database 126 may contain additional data received from the node network 106, such as temperature or weather data.

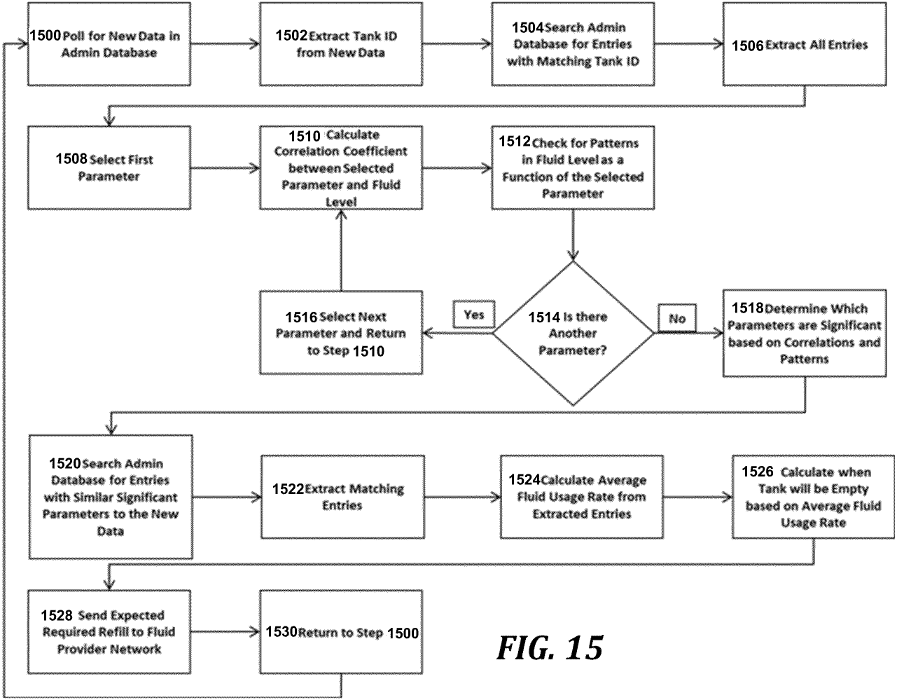

Functioning of the Expected Refill Module 139 will now be explained with reference to FIG. 15.

FIG. 15 displays the functioning of the expected refill module 139. The process may begin with the expected refill module 128 polling for new data in the admin database 126 in step 1500. New data may correspond to data that has just been received by the admin network 124 that originated at the sensor 104. New data may correspond to data that was newly created or updated. New data may also correspond to the latest data in the admin database 126. In embodiments, the new data may include predictive data such as temperature, humidity, wind speed, etc., from a weather service. In step 1502, the expected refill module 139 may extract identifying information (e.g., the tank ID) from the new data. The expected refill module 139 may extract the identifying information from the new data, in which case the result of the expected refill module 139, may be based on general data about the tank model, individual data on the tank, or both.

The expected refill module 139 may, in step 1504, search the admin database 126 for entries matching the received identifying information (e.g., entries with a matching tank ID). This may correspond with all data from the fluid tank 102 with the extracted tank ID that has been recorded in the admin database 126. At step 1506, the expected refill module 139 may extract all matching entries from the admin database 126.

In step 1508, the expected refill module 139 may select the first parameter (for example, temperature, humidity, time, pressure, etc.) from the extracted data. The expected refill module 139 may calculate a correlation coefficient between the selected parameter and the fluid usage (or change in fluid level of the fluid tank) in step 1510. The correlation may be determined by linear correlation or non-linear correlation. Correlation may be calculated using a scatter diagram method, Karl Pearson’s method, Spearman’s rank method, least square method, any other method known in the art, or any combination of methods.

For example, using Karl Pearson’s method to find a linear correlation coefficient between fluid usage and temperature may result in a correlation coefficient of -0.96, meaning the fluid usage and temperature are highly correlated and negatively correlated. In this example, fluid usage increases as the temperature gets colder, which may be expected if the fluid in the fluid tank 102 is propane used to heat a house. In a second example, using Karl Pearson’s method to find a linear correlation coefficient between fluid usage and humidity results in a correlation coefficient of 0.15, meaning the fluid usage and the humidity are not highly correlated. This weak correlation may indicate that the amount of fluid used is not dependent on the humidity.

At step 1512, the expected refill module 139 may check for patterns in fluid level as a function of the selected parameter. Because of the cyclic nature of certain parameters, correlation alone may not capture the significance of the effect of the parameters on fluid usage.

For example, the parameter time may not be correlated with changes in fluid usage rate. However, periods such as the hour of the day, day of the week, day of the year, the month of the year, etc., may have a relationship with fluid usage. For example, fluid usage for a fluid tank 102 may be lower than the average on Thursdays because the factory that uses the fluid tank 102 is closed on Thursdays. Pattern recognition methods may include cross-correlation, windowed dynamic time warping, symbolic aggregate approximation, Hidden Markov modeling, deep learning methods, any other method known in the art, or any combination of methods.

At step 1514, the expected refill module 139 may determine if another parameter in the new data entry has not been checked for patterns or correlations with fluid usage.

If there is another parameter (YES at step 1514), the expected refill module CCC may, at step 1516, select the next parameter and return to step 1510.

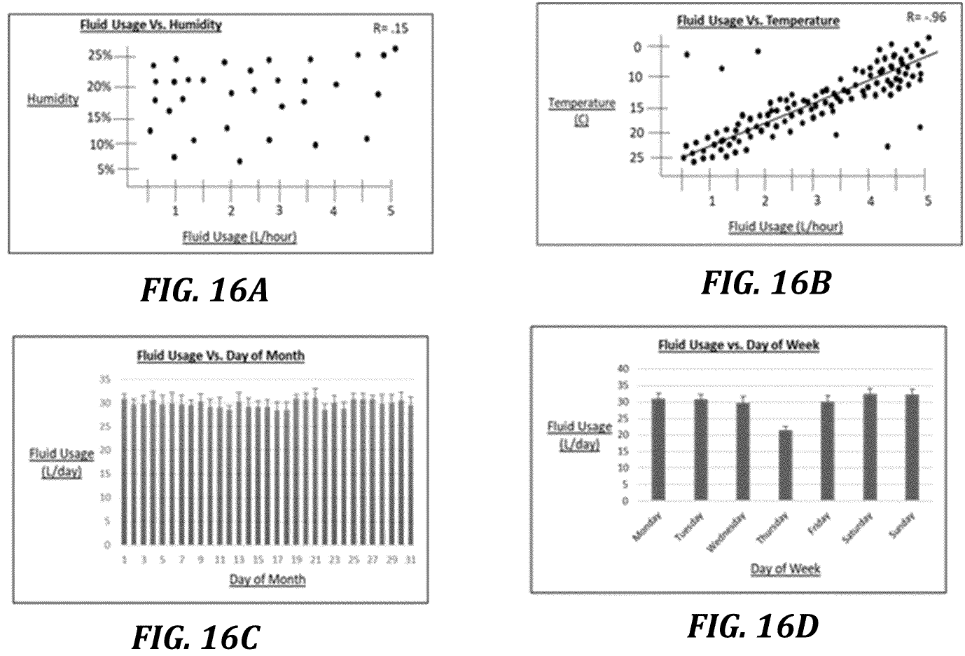

If there are no other parameters (NO at step 1514), the expected refill module 139 may determine which parameters are significant at step 1518. Significant parameters may be parameters for which there is a strong correlation or established pattern. For correlations, a parameter may be significant if the absolute value of the correlation coefficient exceeds a particular threshold. For example, a parameter may be significant if the absolute value of the correlation is greater than 0.80, as shown in FIG. 16B. For patterns, a parameter may be significant if one standard deviation of the sub-category of the parameter does not overlap with one standard deviation of another sub-category of the parameter, as shown in FIG. 16D.

These significance thresholds may be based on or altered by other statistical concepts such as standard error, variance, deviation from the mean, etc. These significance thresholds may be static or dynamic and may be set by an administrator, a user of the system, or another module.

In step 1520, the expected refill module 139 may search the admin database 126 for entries with similar values for significant parameters as the new data entry. Similar may mean that the values are close or equal. As one particular example, if the new data entry shows that a tank with tank ID 1234 has a temperature of 24C, the humidity around the tank is 17%, and it is currently 1:55 PM on a Monday. Temperature and hour of the day may have been determined to be significant parameters for this tank; while humidity and day of the week are not. The expected refill module 139 may search for all entries in the admin database 126 with a temperature between 23-25C and timestamp between 1:30 PM and 2:30 PM. This search may be limited by the tank ID in the new data entry or may include all tanks of the same model, all tanks with the same fluid, all tanks of the same size with the same fluid, etc. If the number of results returned by the search is insufficient (e.g., below a threshold number of results), the search may be expanded by dropping the least significant parameters or expanding the range of values considered similar.

The expected refill module 139 may extract the matching entries from the admin database 126 in step 1522. Many of these extracted entries may be in groups of entries that are close in time, in which case fluid usage may be calculated based on a change in fluid level as a function of time. In some embodiments, one or more additional entries may be extracted that are not matching, but are useful to calculate more accurate fluid usage. In step 1524, the expected refill module 139 may calculate the average fluid usage rate based on the data from the extracted entries. The calculation may be done by taking the fluid level of each extracted entry and comparing it with the next entry chronologically. For example, if the fluid level in an entry at 1:00 PM is 400 L and the fluid level at 1:10 is 399 L, then the fluid usage rate is 1 L per 10 minutes, or 6L per hour. Then all these values are averaged. The expected refill module 139 may weight the average. For example, newer entries or entries that are more similar to the new data entry may have a larger influence on the average. The expected refill module 139 may calculate when the fluid tank 102 is expected to be empty in step 1526. In embodiments, the calculation may be performed by taking the current fluid level and determining when the fluid level will be 0 based on the average fluid usage rate calculated in step 1524. For example, if the current fluid level is 1500 gallons and the fluid usage rate is 15 gallons per day, the tank will be empty in 100 days.

In step 1528, the expected refill module 139 may send the expected date to be empty to the fluid provider network 140. The expected refill module 139 may send other relevant data, such as when the tank will be 20% full, which parameters are significant to this fluid tank, and/or the calculated average fluid usage rate. At step 1530, the expected refill module 139 may return to step 1500.

FIGS. 16A-16D show examples of the correlation coefficient calculations performed by the expected refill module 139.

FIG. 16A shows a graph of humidity compared to fluid usage. Here the data correlation coefficient (R) is 0.15, indicating that the data is weakly correlated or not correlated. In this example, humidity likely has no significant effect on fluid usage. FIG. 16B displays a graph of temperature compared to fluid usage. Here the data correlation coefficient (R) is -0.96, indicating that the data is strongly and negatively correlated. In this example, the temperature has a significant effect on fluid usage. FIG. 16C displays a graph of fluid usage on each day of any given month. Here the average fluid usage for each day of the month is roughly the same, with no one day falling outside of one standard deviation of another day. In this example, there is no significant effect of the day of the month on fluid usage. FIG. 16D displays a graph of fluid usage on each day of any given week. Here the average fluid usage on Thursday is much different than the other days of the week, such that one standard deviation from the average fluid usage on Thursday does not overlap with one standard deviation from the average of any other day. In this example, there is a significant effect of the day of the week on fluid usage.

FIG. 17 shows yet another embodiment of a system 100⁗ for fluid tank management. This system includes a fluid tank 102, which may be any container that contains a fluid. For example, a propane tank, an oxygen tank, a water bottle, a canister of liquid nitrogen, a bag of saline solution, a container of pressurized carbon dioxide, etc.

A sensor 104 may be a device that detects at least one property or parameter of the fluid tank 102, such as, but not limited to, fluid level, pressure, temperature, etc. For example, the sensor 104 may comprise a hall effect sensor that detects the movement of a magnet that is connected to a float inside a propane tank.

The sensor 104 may be connected to a gateway device 116 and/or a user device 120 by a network 106. In some embodiments, the network 106 may be formed as a node network, a hub and spoke network, or any other network architecture suitable for conveying data between the sensor 104 and the gateway device 116 and/or user device 120. In some embodiments, the network 106 may include one or more additional devices, such as a repeater, a bridge, a router, a switch, and/or an extender. Data may be communicated between devices within the network using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to or from other nodes or other system elements, such as the sensor 104, the gateway device 116, and/or the user device 120. Each node may represent, for example, a communication endpoint and/or a redistribution point within the network.

A node may be an electronic device attached to a network and capable of creating, receiving, and/or transmitting information. Nodes may be self-contained wireless communication devices that can communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc. The nodes in the network 106 may be contained within other system elements such as the gateway device 116 and/or sensor 104. In addition, nodes may be contained in a housing, such as a plastic container containing space for the electronics that comprise the node. A node may refer to the electronics that perform the communications or refer to both the electronics and housing. The network 106 may be comprised of three nodes: a sensor node 108, which is fixed near or at the sensor 102; a gateway node 110, which is fixed near or at the gateway device 116; and a temporary node 112, which is mobile or otherwise temporary.

In some embodiments, the network 106 may include additional nodes 114 to create a mesh network, a hub and spoke network, a linear topology network, or any other network topology for communicating data among the network nodes, and/or to provide additional network functionality. Some of the additional nodes 114 may be alternate versions of the three nodes discussed above (e.g., the sensor node 108, the gateway node 110, and the temporary node 112). For example, there may be two nodes that are fixed near the sensor 102, both of which may be sensor nodes 108 such that if one node fails, the other node can still transmit data from the sensor 104 to other nodes on the network 106. Additional nodes 114 may be intermediate nodes that neither receive data directly from the sensor 104 nor transmit data directly to the gateway device 116, but instead transfer data from one node to another to increase the range of the signal, ensure data integrity, or facilitate the integration of the temporary node 112 into the network 106.

A sensor node 108 may be a node that receives data from the sensor 104. Data may be transmitted to the node via wired or wireless communication from the sensor 104. The sensor node 108 may be configured to read data from the sensor if the sensor is analog or is otherwise not configured for transmission of data. There may be more than one sensor node 108, which node operates as the sensor node 108 may change based on connection strength between the sensor and nodes in the network 106. The sensor node 108 may be connected to the sensor 104, which may detect a parameter, such as fluid level, of the fluid tank 102. For example, the sensor 104 may read the position of the level gauge needle on the propane tank. The sensor node 108 may be attached to a support, which allows it to mount to the fluid tank 102 and/or the sensor 104. Due to the obstacles and obstructions, the sensor node 108 may not be able to communicate with the gateway node 110 directly. One or more additional nodes 114 may be placed in a location that allows the one or more additional nodes to relay wireless communications around obstacles and obstructions. In cases where there is little or no obstruction, the gateway node 110 and the sensor node 108 may be the same node.

A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap. This is the normal round trip of measurement data transmission and acknowledgment reception. When the admin network 124 receives the data, it may log these data, run a trend analysis or other analysis, and/or initiate a service action. One non-limiting example of a service action may be scheduling a propane delivery because the tank level is low, and other logistical factors contribute to the conclusion to make such delivery. Another example of a service action may be a network maintenance action, such as initiating a replacement action if any of the nodes in the network 106 were to report that its battery is low enough to require replacement. The replacement action may be replacing the battery or the entire node.

A temporary node 112 may be a node that temporarily connects to the network 106 to send and receive data from one or more other nodes. This data may be passed on to the gateway node 110 and/or to other nodes in the network. The temporary node 112 may be mobile, such that one node could join multiple networks 106 based on proximity. The temporary node 112 may be able to send data directly to the user device 124 when access to the cloud or internet 118 is unavailable. For example, a service technician may carry a temporary node 112 so that they can integrate with any network 106 and access data without being connected to the cloud or internet 118. The temporary node 112 may be a node that has augmented equipment allowing direct display of network parameters and command functions to the user. In this case, the user may be a service representative. The temporary node 112 may be useful for network maintenance, especially if the gateway mechanism is unavailable, rendering the local RF network “invisible” to the remote system. If the gateway device 116 and internet connectivity is operational, an alternate method for the service person to use would be accessing the network information via a user device 120 or a web page associated with the admin network 124 on an internet-connected device. The temporary node 112 may not be ported by the service person but instead the delivery or service vehicle. Valuable data may be obtained by understanding when this temporary node 112 may have joined a local network and how long it was present. If attached to a delivery vehicle, the temporary node 112 may have its own measurement module(s) and may be able to provide data about the transfer from a tank on the vehicle to the fluid tank 102.

Zero or more additional nodes 114 may facilitate the communication of data within the network 106. For example, if the sensor node 108 is too far from the gateway node 110 to communicate, or there is an obstruction blocking communication, then one or more additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem, or may be a router that sends data to a modem that sends data to the cloud or internet 118.

In disclosed embodiments, the network 106 may be in operative communication with a cloud or internet 118, which may be a wired or a wireless network. The network 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 118 may allow ubiquitous access to shared pools of configurable system resources and higher-level services that can be rapidly provisioned with minimal management effort and relies on sharing of resources to achieve coherence and economies of scale, like a public utility. In some embodiments, third-party clouds enable organizations to focus on their core businesses instead of expending resources on computer infrastructure and maintenance.

A user device 120 may be any device that can receive information from the cloud or internet 118 such as a laptop, smartphone, tablet, computer, or smart speaker. The user device 120 may also be a device that can receive and/or send information to one or more nodes on the network 106.

A management app 122 may be an application on the user device 120 that can display information associated with the fluid tank 102 obtained from the admin network 124 or directly from the network 106. The management app 122 may allow a user or service technician to affect elements of the system. For example, the management app 122 may allow a user or service technician to remotely drain the fluid tank 102, cut off the flow of fluid out of the fluid tank 102, reset the network 106, etc. The management app 122 may allow a user or service technician to receive information from and/or control the system. The user may be the owner or user of the fluid tank 102, a technician, an agent of a tank refilling company, a regulator, etc. The management app may receive data from the admin network 124 if a connection to the network is available. If a connection to the admin network 124 is unavailable, the management app 122 may connect directly to the network 106. In some embodiments, connection to the network 106 may require proximity to at least one node of the network.

This node may be the temporary node 112, which may be part of, or otherwise connected to, the user device 120. For example, the user device may be a smartphone attached via USB-C cable to a temporary node 112. The temporary node 112 may sync up to a nearby network 106 such that the user device 120 can obtain information from the network 106 through the connection with the temporary node 112. The user device and temporary node 112 may be the same device or may be housed in the same container. For example, a handheld tablet containing an RFID communication device that can receive data from the network 106 may serve as both the user device 120 and the temporary node 112. The management app 122 may display the data from the admin network 124 or network 106 to the user. The user may be able to navigate through the management app 122 to view, format, and/or filter the data. The user may be able to make changes to the system using the management app 122. For example, the user may request early refueling, reboot a node or the network 106, control which data is sent to the admin network 124, etc. Additional elements of the system may also be controlled through the management app 122. For example, an emergency shut-off valve controlled remotely may be activated through the management app 122. Management may be automated through the management app 122. For example, when the fluid level in the fluid tank 102 begins to drop more rapidly than normal, an emergency shut-off valve may be activated via the management app 122 without user intervention.

An admin network 124 may be a computer or network of computers that receives data related to the fluid tank 102 through the cloud or internet 118. This data may then be stored, sent, altered, and/or used in programs or modules.

An admin database 126 may contain data received by the admin network 124. The admin database 126 may contain a record of all data received related to the fluid tank 102 over time. The admin database 126 may contain data from multiple instances of the system. The admin database 126 may contain data from other sources such as (but not limited to) weather data, data from the fluid tank 102 manufacturers, data provided by a user of the system, etc.

A route module 148 may generate many simulated refill routes based on the admin database 126 data and/or other sources such as GPS, weather, local road service, etc. Each simulated route may be scored based on scoring rules stored in the route rules database 149 The route with the highest score is then selected and sent to the fluid refill transport 154.

A route rules database 149 may contain route scoring rules used by the route module 148 to determine if a simulated route is optimal. As one non-limiting example, a rule may dictate that a route gets five score points for each tank refilled along the route. There may be many scoring rules used to evaluate the simulated routes.

A correction module 153 may detect when the actual route of a fluid refill transport 154 differs from the optimal route (e.g., the simulated route having the highest score) or if on-site data differs from the data used to generate the optimal route. If a significant difference is detected between the on-site data and the data used to generate the optimal route, the correction module 153 may reinitiate the route module 148 to generate a new optimized route based on the new data.

A fluid refill transport 154 may transport fluid to the fluid tank 102 and facilitate the refill of the fluid tank 102. The fluid refill transport 154 may be a vehicle capable of transporting fluid, such as a propane truck, a van carrying water tanks, a drone carrying liquid medicine, etc. In addition, the fluid refill transport 154 may be in communication with a fluid provider network and may send updates on the status of the fluid refill transport 154 and/or the fluid tank 102 being refilled.

A refill transport node 136 may be attached to or associated with the fluid refill transport 134. The refill transport node 136 may be a temporary node 112. The refill transport node 136 may collect information associated with the fluid tank 102 being refilled by the fluid refill transport 154 directly from the network 106. This data may be used to conduct the refill and/or may be transmitted to the fluid provider network. If the fluid refill transport 154 has no direct connection with the fluid provider network, the refill transport node 136 can send or receive data over the cloud or internet 118 by integrating with the local network 106. In addition, the refill transport 134 node may be able to cache data in a short-term database to be uploaded to the fluid provider network when access is available.

One or more transport sensors 138 may detect parameters of the fluid refill transport 154 such as (but not limited to) refill tank level, gas level, battery charge, speed, etc.

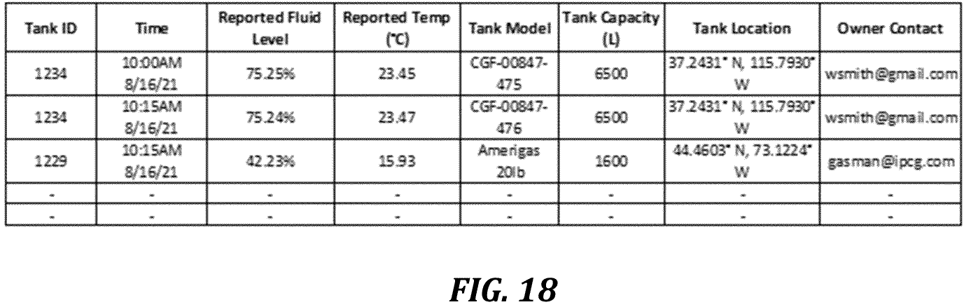

Another embodiment of the admin database 126 will now be explained with reference to FIG. 18.

FIG. 18 displays the admin database 126. The admin database 126 may contain identifying information for a fluid tank 102. For example, a tank ID, the make or model of the tank, the location of the tank, and contact information for the owner or manager of a tank. The admin database 126 may contain the data received about the fluid level of the fluid tank 102. This data may be timestamped and may be saved in the database continuously, at regular intervals such as every 5 minutes, every 15 minutes, every hour, etc., or at irregular intervals based on measured, calculated, and/or anticipated usage. The admin database 126 may contain data related to features of the tank that would be useful in determining when the tank will need to be filled, such as (but not limited to) the total tank capacity. Some of this data, such as tank capacity, may be obtained from sources outside the admin network 124, such as the manufacturer’s website. The admin database 126 may contain additional data received from the network 106, such as temperature or weather data.

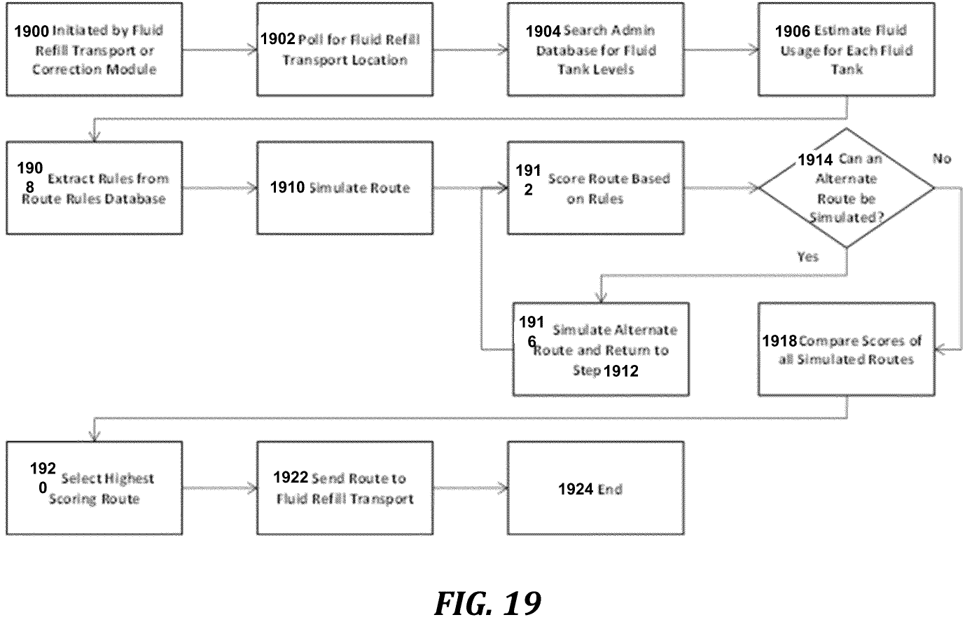

Functioning of the Route Module 148 will now be explained with reference to FIG. 19.

FIG. 19 displays the functioning of the route module 148. The process may begin at step 1900 with the route module 148 being initiated by the fluid refill transport 154. In some embodiments, initiation of the route module 148 may be done manually by a driver of the fluid refill transport 154 or automatically when the fluid refill transport 154 is started or begins to move. In other embodiments, the route module 148 may be initiated by the correction module 153 in response to an error in a route and/or receipt of new data that would affect which route is the optimal route. The route module 148 may also run periodically or constantly when resources are available or when the time required to compute an optimized route is high.

In step 1902, the route module 148 may poll for data indicating the location of the fluid refill transport 154. The location may be sent from the refill transport node 136 if there is a connection to the cloud or internet 118 if the refill transport node 136 has a direct connection to the cloud or internet, or if the refill transport node 136 has integrated with a network 106 that has a connection to the cloud or internet 118. The location may be, for example, GPS coordinates, or any other data that provides location information. The route module 148 may, in step 1904, search the admin database 126 for fluid levels associated with monitored fluid tanks. The search may be limited to a set area (for example, fluid tanks in the same city or county as the fluid refill transport 154).

In step 1906, the route module 148 may estimate fluid usage for each fluid tank found in step 1904. In embodiments, the estimate may be based at least in part on historical usage data. Data on upcoming conditions may modify this estimate. For example, an expected drop in temperature may increase the estimated fluid usage by 30% in the affected area.

The route module 148 may extract the rules from the route rules database 149, at step 1908. In step 1910, the route module 148 may simulate a possible route that the fluid refill transport 154 may take to refill some or all the fluid tanks identified in step 1904. The simulated route may begin where the fluid refill transport 154 is currently located. In embodiments, the simulated route may end at the same location, a designated location, or wherever the last fluid tank 102 on the route is. The simulated route may consider when the fluid refill transport 154 may need to stop to refill, refuel, or recharge. The simulated route may allocate a certain amount of fluid to each fluid tank along the route. The amount of fluid allocated to each tank may be equal, or the amounts may vary based on one or more factors such as (but not limited to) tank capacity, amount of fluid in each tank, amount of fluid in the fluid refill transport 154, expected fluid usage, etc. For example, at a first stop, the fluid refill transport 154 may unload 120 gallons of fluid to fill a fluid tank, then at a second stop, the fluid refill transport may unload 150 gallons of fluid to fill a fluid tank to 50% capacity.

In step 1912, the route module 148 may score the simulated route from step 1910 based on the extracted rules from the route rules database 149. For example, the following example rules may be applied to the route: -1 point for each mile over the shortest route, 2 points for each tank refilled to full, -2 points for each stop. If the simulated route is the shortest, refills ten tanks, and stops twice, then the simulated route will have a score of 16. Those of skill in the art will recognize the more, fewer, or different rules may also be applied to determine a score for the simulated route. If a similar route has already been scored, the route module 148 may adjust the score from a similar route based on the differences between the similar route and the currently simulated route.

In step 1914, the route module 148 may determine if an alternate route may be simulated. This determination may depend on if there are any more possible routes to simulate. This determination may also be based, at least in part, on the amount of time or resources that each simulation requires, the scores of previously-simulated routes, and/or if there is a cap on the number of routes to be simulated. For example, the route module 148 may be set to generate and score new simulated routes for up to a minute, until 10 routes have been generated, or until a generated route has a score exceeding a predetermined threshold.

If an alternate route may be simulated (YES in step 1914), the route module 128 may, in step 1916, simulate an alternate route similar to step 1910, then returns to step 1912 to score the newly simulated route. The alternate route may be generated by making changes to a previously simulated route. Simulated routes may be generated procedurally. For example, the first route generated may be the shortest, then the fastest route, then the route that fills the most tanks to full, then the route that fills the most tanks enough to make it to the next refill, etc.

If an alternate route is not to be simulated (NO in step 1914), the route module 148 may compare the scores of all the simulated routes in step 1918. For example, the route module 148 may compare all simulated routes to determine which simulated route has the highest score. Alternatively, the route module 148 may track which simulated route is the highest scoring and discard each new route with a lower score. At step 1920, the route module 148 may select the highest scoring route. If one or more routes is tied for the highest score, the route module 148 may select from among the highest-scoring routes using a tiebreaker rule, by selecting the first generated route, or by selecting one randomly.

In step 1922, the route module 148 may send the route to the fluid refill transport 154 and/or another device such as (but not limited to) a user device 120. In this way, the route data is made available to an operator of the fluid refill transport 154. The route module 148 may stop, pause, halt, or end at step 1924.

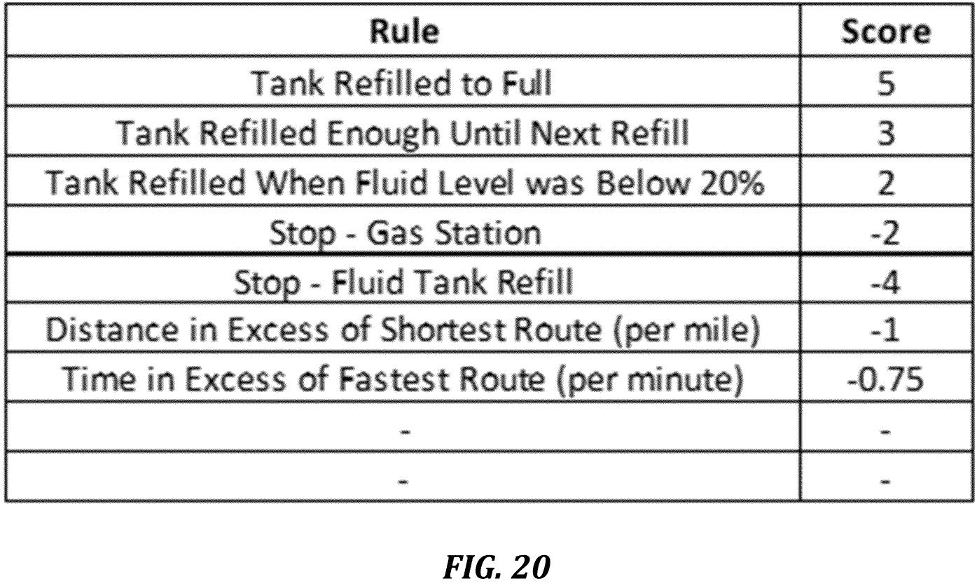

An embodiment of the Route Rules Database 149 is illustrated in FIG. 20.

FIG. 20 displays the route rules database 149. The route rules database 149 may contain route scoring rules which may increase or decrease the score of a simulated route. For example, as shown in FIG. 20, a rule decreases the score of a route by one point for each mile of distance the fluid refill transport 154 travels in excess of the shortest route distance. This rule would mean that extra miles on a simulated route would be detrimental to the route’s score, but could be overcome if a few extra miles of distance increased the route’s score based on other rules. In some embodiments, a route may receive a score increase from a rule multiple times. For example, FIG. 20 shows a rule that increases the score of a simulated route by five points for refilling a fluid tank in full. The score may be increased multiple times if multiple fluid tanks are refilled to full. This rule would mean that if a simulated route fills ten tanks, the route’s score would be increased by 50 points based on this rule.

In some embodiments, rules may not be exclusive, and a single condition of the route may cause multiple rules to be applied on the same route. For example, FIG. 20 shows a first rule that increases the score of a simulated route by three points whenever a fluid tank 102 is filled enough to last until the next refill based on consumption needs; and a second rule that increases the score of a simulated route by two points when a tank below 20% capacity is filled. If a simulated route includes refilling a tank at 10% with enough fluid to last until the next refill, both rules will apply, and the score associated with the simulated route would increase by five points. The scores given upon fulfillment of each rule by a simulated route may be static or dynamic. The scores may be set by an administrator of the system, a system user, a third party, or another module.

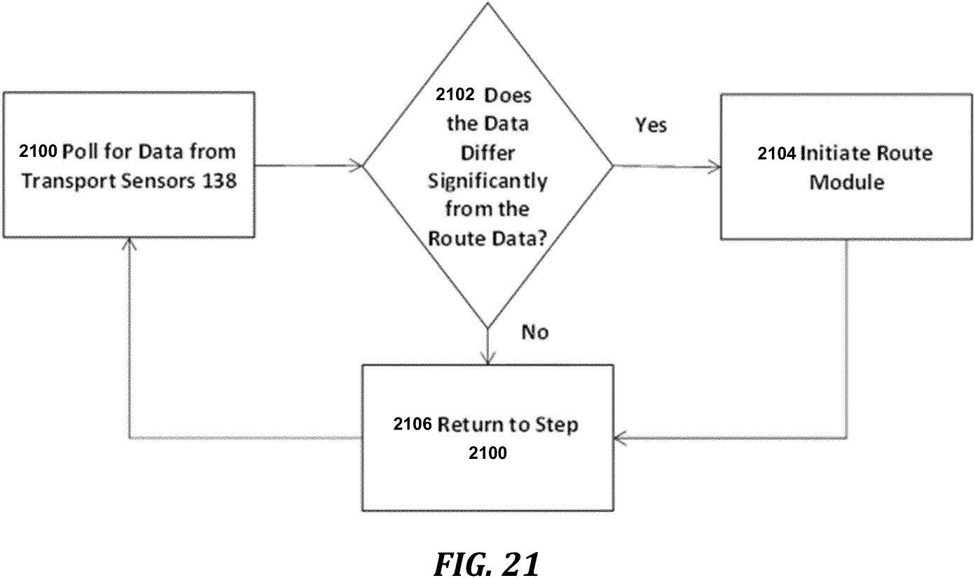

Functioning of the Correction Module 153 will now be explained with reference to FIG. 21.

FIG. 21 displays the functioning of the correction module 153. The process begins at step 2100 with the correction module 153 polling for data from the transport sensors 138. This data may include, for example, transport fluid level, transport fuel level, transport GPS location, transport speed, etc. At step 2102, the correction module 153 may determine if the data from the transport sensors 138 differs significantly (e.g., varies by more than a threshold) from expected readings based on assigned route data. For example, the threshold may be 5% of the route data. As a particular example, if the fluid refill transport 154 was stuck in unexpected traffic and was traveling 50% slower, unloaded 10% more fluid at a fluid tank 102 than expected, or burned 6% more fuel than expected, the correction module 153 may determine that the corresponding sensor reading is significantly different than the expected reading. Other events may also register as significant even if the threshold (e.g., the percentage difference) is not applicable. For example, the fluid refill transport 154 may make a wrong turn, or communication with the fluid refill transport 154 may be lost for more than a predetermined time period (e.g., a few minutes). The threshold for a significant difference may be higher or lower than 5%, may be static or dynamic, and may be set by an administrator of the system, user of the system, or another module.

If the difference is determined to be significant (YES in step 2102), the correction module 153 may initiate the route module 148 to generate a new route based at least in part on the new data (e.g., the data received from the transport sensors 138) at step 2104.

Following initiation of the route module in step 2104, or if the difference between the polled data and the expected data is determined not to be significant (NO in step 210), the process may proceed to step 2106, where the correction module 153 may return to step 2100.

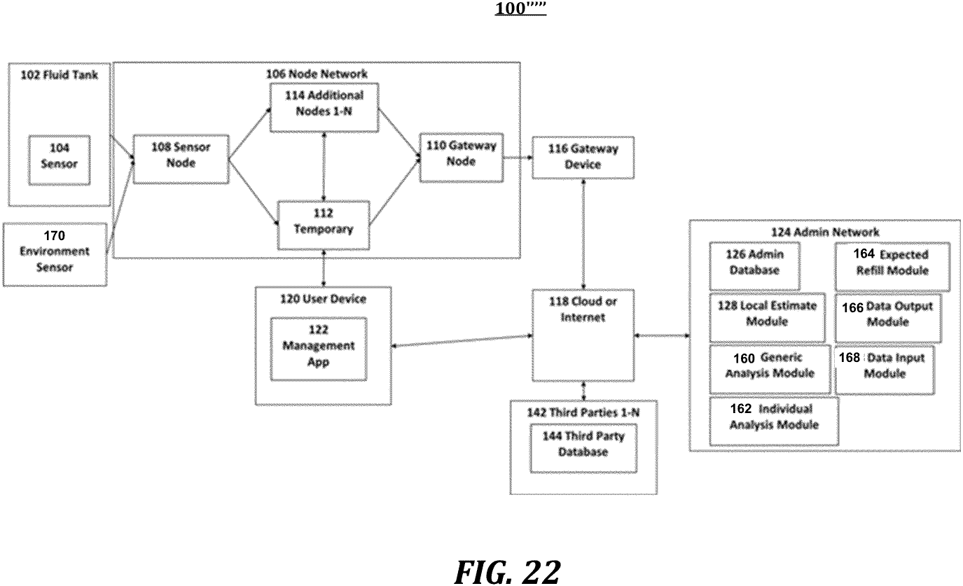

FIG. 22 shows another embodiment of a system 100‴″ for fluid tank management. This system includes a fluid tank 102, which may be any container that contains a fluid. For example, a propane tank, an oxygen tank, a water bottle, a canister of liquid nitrogen, a bag of saline solution, a container of pressurized carbon dioxide, etc.

A sensor 104 may be a device that detects at least one parameter of the fluid tank 102, such as fluid level, pressure, temperature, etc. For example, the sensor 104 may be a hall effect sensor that detects the movement of a magnet that is connected to a float inside the tank 102.

The sensor 104 may be connected to a gateway device 116 and/or a user device 120 by a network 106. In some embodiments, the network 106 may be formed as a node network, a hub and spoke network, or any other network architecture suitable for conveying data between the sensor 104 and the gateway device 116 and/or user device 120. In some embodiments, the network may include one or more additional devices, such as a repeater, a bridge, a router, a switch, and/or an extender. Data may be communicated between devices within the network 106 using wired and/or wireless communication methods. For example, network communication may adhere to standards set forth by the institute for electrical and electronic engineers (IEEE) standards in the 802 working group, including IEEE 802.3 ethernet communication standards, 802.11 wireless local area network (WLAN) standards, 802.15 wireless personal area network (e.g., Bluetooth, ZigBee, etc.) standards, and/or the like. In embodiments, the network 106 may be a network of interconnected nodes that transmit data to and/or from other nodes or other system elements, such as the sensor 104, the gateway device 116, and/or the user device 120. Each node may represent, for example, a communication endpoint and/or a redistribution point within the network.

A node may be an electronic device attached to a network and capable of creating, receiving, and/or transmitting information. Nodes may be self-contained wireless communication devices that can communicate with other nodes and devices via wireless communication methods such as RFID, NFC, Bluetooth, Wi-Fi, Li-Fi, Radio Frequency (RF) communication, such as binary phase shift keying (BPSK) over ISM band spectra, etc. The nodes in the network 106 may be contained within other system elements such as the gateway device 116 and/or sensor 104. In addition, nodes may be contained in a housing, such as a plastic container containing space for the electronics that comprise the node. A node may refer to the electronics that perform the communications or refer to both the electronics and housing.

The network 106 may be comprised of three nodes: a sensor node 108, which is fixed near or at the sensor 102; a gateway node 110, which is fixed near or at the gateway device. In some embodiments, the network 106 may include additional nodes 114 to create a mesh network, a hub and spoke network, a linear topology network, or any other network topology for communicating data among the network nodes, and/or to provide additional network functionality. Some of the additional nodes 114 may be alternate versions of the three nodes discussed above (e.g., the sensor node 108, the gateway node 110, and the temporary node 112). For example, there may be two nodes that are fixed near the sensor 102, both of which may be sensor nodes 108 such that if one node fails, the other node can still transmit data from the sensor 104 to other nodes on the network 106. Additionally or alternatively, the additional nodes 114 may be intermediate nodes that neither receive data directly from the sensor 104 nor transmit data directly to the gateway device 116, but instead transfer data from one node to another to increase the range of the signal, ensure data integrity, and/or facilitate the integration of the temporary node 112 into the network 106.

A sensor node 108 may be a node that receives data from the sensor 104. Data may be transmitted to the sensor node 108 via wired or wireless communication from the sensor 104. The sensor node 108 may be configured to read data from the sensor if the sensor is analog, or is otherwise not configured to transmit data to each sensor node. There may be more than one sensor node 108, and which node is operating as the sensor node 108 may change based on connection strength between the sensor and nodes in the network 106. The sensor node 108 may be connected to the sensor 104, which may detect a parameter, such as fluid level, of the fluid tank 102. For example, the sensor node 108 may read the position of the level gauge needle on the propane tank. The sensor node 108 may be attached to a support, which allows the sensor node to be mounted to the fluid tank 102 and/or the sensor 104. Due to obstacles and obstructions, the sensor node 108 may not be able to communicate with the gateway node 110 directly. One or more additional nodes 114 may be placed in a location that allows the one or more additional nodes to relay wireless communications around obstacles and obstructions. In cases where there is little or no obstruction, the gateway node 110 and the sensor node 108 may be the same node.

A gateway node 110 may be a node that sends data received from other nodes to the gateway device 116. The gateway device 116 and the gateway node 110 may be the same device, or one may contain the other. The gateway node 110 may transmit data from the network 106 to the gateway device 116. The gateway node 110 and the gateway device 116 may be adjacent, attached, or contained in the same enclosure. When data is received by the gateway device 116 or the admin network 124, the receiving element may acknowledge receipt, and the gateway node 110 may broadcast this success to all nodes in range. If, for example, the sensor node 108 is out of range, it will still be waiting and may re-try transmission at the next low-power-managed interval. However, an additional node 114 may be able to accept the acknowledgment and relay it to the sensor node 108 at such time as their listening and transmission intervals overlap. This is the normal round trip of measurement data transmission and acknowledgment reception. When the admin network 124 receives the data, the admin network may log these data, run a trend analysis or other analysis, and/or may initiate a service action based on the received data. The service action may be, as a non-limiting example, scheduling a propane delivery because the tank level is low, and other logistical factors contribute to the conclusion to make such delivery. As another non-limiting example, the service action may be a network maintenance action, such as initiating a replacement action if any of the nodes in the network 106 were to report that its battery is low enough to require replacement. The replacement action may include replacement of the battery or an entire node.

A temporary node 112 may be a node that temporarily connects to the network 106 to send data to and/or receive data from other nodes. This data may be passed on to the gateway node 110 and/or other nodes in the network 106. The temporary node 112 may be mobile, such that one node could join multiple networks 106 based on proximity. The temporary node 112 may be able to send data directly to the user device 120 when access to the cloud or internet 118 is unavailable. For example, a service technician may carry a temporary node 112 so that they can integrate with any network 106 and access data without being connected to the cloud or internet 118. The temporary node 112 may be a node that has augmented equipment allowing direct display of network parameters and command functions to the user. In this case, the user may be a service representative. The temporary node 112 may be useful for performing network maintenance, especially if the gateway device 116 is unavailable due to rendering the local RF network “invisible” to a remote system. If the gateway device 116 and internet connectivity is operational, an alternate method for the service person to use would be accessing the network information via a user device 120 or a web page associated with the admin network 124 on an internet-connected device. The temporary node 112 may not be ported by the service person but instead the delivery or service vehicle. Valuable data may be obtained by understanding when the temporary node 112 may have joined a local network and how long it was present. If attached to a delivery vehicle, the temporary node 112 may have its own measurement module(s) and may be able to provide data about the transfer from a tank on the vehicle to the fluid tank 102.

Zero or more additional nodes 114 may facilitate the communication of data within the network 106. For example, if the sensor node 108 is too far from the gateway node 110 to communicate, or there is an obstruction blocking communication, then one or more additional nodes 114 may be used to repeat the signal and ensure the data from the sensor node 108 reaches the gateway node 110.

A gateway device 116 may be a device that allows for data to be sent through the cloud or internet 118. The gateway device 116 may not be the only device between the network 106 and the cloud or internet 118. For example, the gateway device 116 may be a modem, or may be a router that sends data to a modem that sends data to the cloud or internet 118.

The cloud or internet 118 may be a wired or a wireless network. The network 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. In some embodiments, third-party clouds enable organizations to focus on their core businesses instead of expending resources on computer infrastructure and maintenance.

A user device 120 may be any device that can receive information from the cloud or internet 118 such as a laptop, smartphone, tablet, computer, or smart speaker. The user device 120 may be a device that can receive or send information to one or more nodes on the network 106.

A management app 122 may be an application on the user device 120, and can display information associated with the fluid tank 102 obtained from the admin network 124 and/or directly from the network 106. The management app 122 may allow a user or service technician to affect elements of the system. For example, the management app 122 may allow a user or service technician to remotely drain the fluid tank 102, cut off the flow of fluid out of the fluid tank 102, reset the network 106, etc. The management app 122 may allow a user or service technician to receive information from and/or control the system. The user may be the owner or user of the fluid tank 102, a technician, an agent of a tank refilling company, a regulator, etc. The management app 122 may receive data from the admin network 124 if a connection to the network is available. In some embodiments, (e.g., if a connection to the admin network 124 is unavailable), the management app 122 may connect directly to the network 106. In some embodiments, connection to the network 106 may require proximity to at least one node of the network. This node may be the temporary node 112, which may be part of, or otherwise connected to, the user device 120. For example, the user device 120 may be a smartphone attached via USB-C cable to a temporary node 112. The temporary node 112 may sync up to a nearby network 106 such that the user device 120 can obtain information from the network 106 through the connection with the temporary node 112. The user device 120 and temporary node 112 may be the same device or may be housed in the same container. For example, a handheld tablet containing an RFID communication device that can receive data from the network 106 may serve as both the user device 120 and the temporary node 112.

The management app 122 may display the data from the admin network 124 and/or the network 106 to the user. The user may be able to navigate through the management app 122 to view, format, and/or filter the data. The user may be able to make changes to the system using the management app 122. For example, the user may request early refueling, reboot a node or the network 106, control which data is sent to the admin network 124, etc. Additional elements of the system may also be controlled through the management app 122. For example, an emergency shut-off valve controlled remotely may be activated through the management app 122. Management of the system may be automated through the management app 122. For example, when the fluid level in the fluid tank 102 begins to drop more rapidly than normal, an emergency shut-off valve may be activated without user intervention.

An admin network 124 may be a computer or network of computers that receives data associated with the fluid tank 102 through the cloud or internet 118. This data may then be stored, sent, altered, and/or used in programs or modules.

An admin database 126 may contain data received by the admin network 124. The admin database 126 may contain a record of all data received related to the fluid tank 102 over time. The admin database 126 may contain data from multiple instances of this system. The admin database 126 may contain data from other sources such as (but not limited to) weather data, data from the fluid tank 102 manufacturers, data provided by a user of the system, etc.

A local estimate module 128 may estimate the fluid used in a tank (e.g., the tank 102) based at least in part on historical data in the admin database 126. This historical data may include both fluid tank data and environment sensor data. For example, fluid tank levels in a propane tank may drop faster than average when the temperature is low because more propane is being used to heat a house. The local estimate module 128 may send the estimated fluid use data to the user device 120.

A generic analysis module 160 may adjust the received fluid level of a fluid tank (e.g., the fluid tank 102) detected by a sensor (e.g., the sensor 104) based on historical data from similar sensors and/or fluid tanks. For example, if all fluid tanks from the same manufacturer flare out at the bottom, then the readings from the sensor may be adjusted to reflect that lower fluid levels will last longer than expected.

An individual analysis module 162 may adjust the received fluid level of a fluid tank (e.g., the fluid tank 102) detected by a sensor (e.g., the sensor 104) based on historical data from that sensor and/or that fluid tank. For example, historical data shows that the fluid in the fluid tank 102 was empty when the sensor 104 reported a fluid level of 10%. The detected fluid level in the fluid tank 102 may be adjusted to reflect that 10% is when the fluid runs out instead of 0% as expected.

An expected refill module 1164 may determine, based at least in part on the known fluid capacity of a fluid tank (e.g., the fluid tank 102), the current fluid level from a sensor (e.g., the sensor 104), and one or more current and/or future parameters, when the fluid tank will need to be refilled.

A data output module 166 may receive data requests from one or more third parties 142, search the admin database 126 for the requested data, and deliver the requested data to one or more third parties 142.

A data input module 168 may request data from one or more third parties 142, poll for a response or otherwise manage receipt of the response, and store the received data (e.g., in the admin database 126).

An environment sensor 170 may be a device that detects one or more environmental parameters such as, but not limited to, temperature, humidity, sunlight, wind speed, etc. The environment sensor 170 may be disposed at the fluid tank 102 or near enough to the fluid tank that the measurements made by the sensor 170 are relevant to environmental conditions at the fluid tank 102. The environment sensor 170 may send data via the network 106 to the admin network 124. Alternatively or additionally, the environment sensor 170 may send data to the sensor node 108 and/or another node on the network 106.

One or more third parties 142 may be entities outside the control of the system that provide data to and/or retrieve data from the administration network 124. Examples of third parties may include, but are not limited to, fluid tank manufacturers, sensor manufacturers, weather forecasting services, road condition services, traffic monitoring services, and any other party that may make use of data tracked by the system and/or may provide data useful to the system.

One or more of the third parties 142 may include a third-party database 144. The third-party database 144 may contain data retrieved from the administration network 124 and/or data to be retrieved by the administration network 124. For example, the third-party database may include weather data, business leads, fluid tank data, etc.

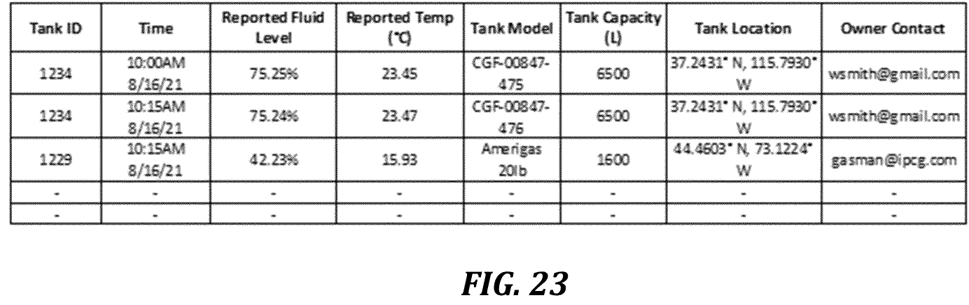

An embodiment of the admin database 126 will now be explained with reference to FIG. 23.

FIG. 23 displays the admin database 126. The admin database 126 may contain identifying information for a fluid tank 102. For example, the identifying information may include one or more of a tank ID, the make or model of the tank, the location of the tank, and/or contact information for the owner or manager of a tank. The admin database 126 may contain the data received about the fluid level of the fluid tank 102. This data may be timestamped and may be saved in the database continuously, at regular intervals, such as every 5 minutes, every 15 minutes, every hour, etc., or at irregular intervals based on measured, calculated, and/or anticipated usage. The admin database 126 may contain features of the tank 102 that would be useful in determining when the tank will need to be filled, such as (but not limited to) the total tank capacity. Some of this data, such as tank capacity, may be obtained from sources outside the admin network 124 (e.g., from a third party 142), such as the manufacturer’s website. The admin database 126 may contain additional data received from the network 106, such as temperature or weather data.

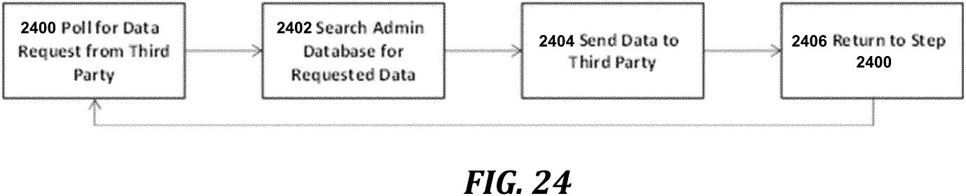

Functioning of the Data Output Module 166 will now be explained with reference to FIG. 24.

FIG. 24 displays the functioning of the data output module 166. The process may begin at step 2400 with the data output module 166 polling for (or otherwise receiving) a data request from a third party 142. As one example, the third party 142 may be a company that refills fluid tanks, and the data request may be for data on the current fluid levels or expected future fluid levels. As another example, the third party 142 may be a lead generation company and the data request may be for data on which users use more than 100 L of fluid per week. The data output module 166 may require credentials or other identifying information before processing a data request.

At step 2402, the data output module 166 may search the admin database 126 for the requested data. The data output module 136 may send the data to the third party 142 at step 2404. In embodiments, sending the data may include sending the actual data, a location at which the data is stored (e.g., a uniform resource indicator), a link to a database including the data, a module including the data, and/or the like. The data may be sent in a format and/or to a location that the third party has requested. Finally, at step 2406, the data output module 166 may return to step 2400.

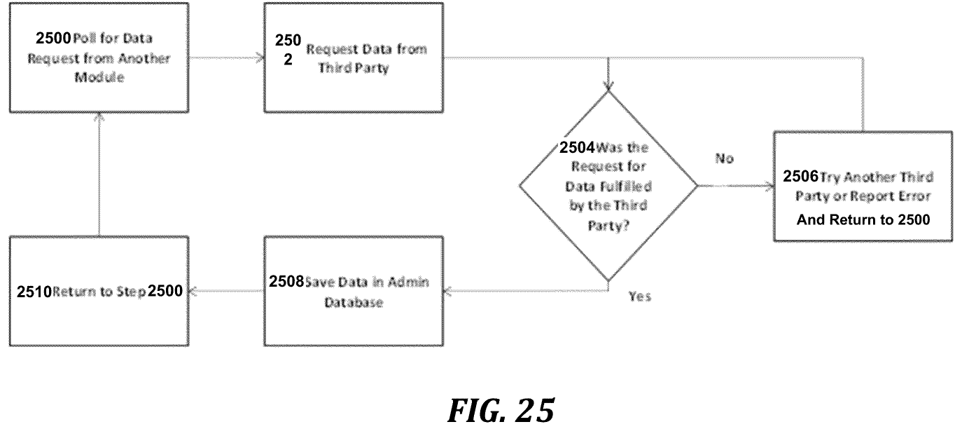

Functioning of the Data Input Module 168 will now be explained with reference to FIG. 25.

FIG. 25 displays the functioning of the data input module 168. The process may begin at step 2500 with the data input module 168 polling for (or otherwise receiving) a request from another module (e.g., a module on the admin network 124). For example, the local estimate module 128 may request weather data be retrieved from one more third parties 142 so that local temperature data can be compared to regional temperatures. As another example, the expected refill module 164 may request purchase data be retrieved from a third party 142 that is a vendor of fluid-using products so that when a user purchases a new fluid-using product, the amount of fluid that the product is expected to use is factored into the expected refill date.

The data input module 168 may, at step 2502 request data from a third party 142. In some embodiments the data request may include a request for access to a third-party database 144 (e.g., so that the data input module may retrieve the requested data). The data input module 138 may receive along with the request for data an identifier for the third party from which the data is requested. In some embodiments, requesting the data may include determining one or more third parties 142 and/or third-party databases 144 may have the requested data, and to which the request should be submitted. At step 2504, the data input module 168 may determine if the request for data was fulfilled by the third party 142. For example, the data input module 168 may poll for a predetermined time period to determine if a response is received from the third party 142 to which the request was transmitted. In some embodiments, if a response is received, determining if the request was fulfilled may further include determining if the response includes the requested data, or is another response (such as an error code).

At step 2506, if the request for data was not fulfilled (NO at step 2504), the data input module 168 may try another third party 142 or third party database 144 if any are expected to have the requested data. Additionally, or alternatively, the data input module 168 may report an error and return to step 2500.

If the request for data was fulfilled (YES at step 2504), the data input module 168 may, at step 2508, save the received data in the admin database 126. In some embodiments, the data input module 168 may send the received data to the module that requested the data. At step 2510, the data input module 138 may return to step 2500.

The functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

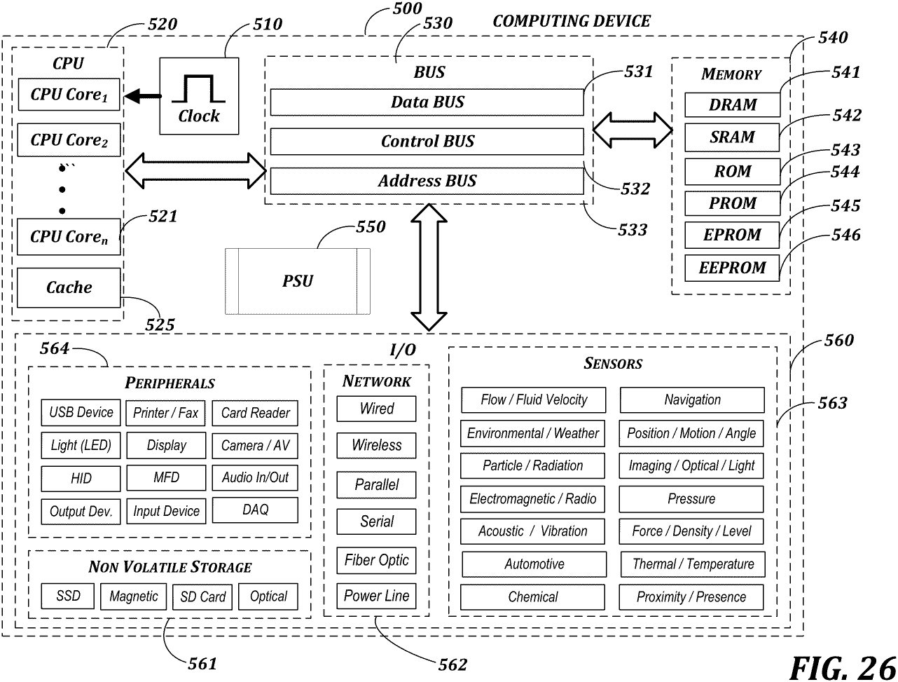

FIG. 26 illustrates a system consistent with an embodiment of the disclosure may include a computing device, such as computing device 500.

The prediction node may be hosted on a centralized server or on a cloud computing service. Embodiments of the present disclosure may comprise a computing device 500 having a central processing unit (CPU) 520, a bus 530, a memory unit 540, a power supply unit (PSU) 550, and one or more Input / Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the prediction node. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

In a basic configuration, computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 400 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 540 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop / electrical parallel topology, a daisy chain topology, and a connected by switched hubs, such as USB bus. The bus 530 may comprise a plurality of embodiments, for example, but not limited to:
Internal data bus (data bus) 531 / Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE) / Enhanced IDE (EIDE), ATA Packet Interface (ATAPI), Ultra-Direct Memory Access (UDMA), Ultra ATA (UATA) / Parallel ATA (PATA) / Serial ATA (SATA), CompactFlash (CF) interface, Consumer Electronics ATA (CE-ATA) / Fiber Attached Technology Adapted (FATA), Advanced Host Controller Interface (AHCI), SATA Express (SATAe) / External SATA (eSATA), including the powered embodiment eSATAp / Mini-SATA (mSATA), and Next Generation Form Factor (NGFF) / M.2.
-Small Computer System Interface (SCSI) / Serial Attached SCSI (SAS)
-HyperTransport
-InfiniBand
RapidIO
Mobile Industry Processor Interface (MIPI)
Coherent Processor Interface (CAPI)
Plug-n-play
-1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt / Mini DisplayPort, Mobile PCIe (M-PCIe), U.2, and Non-Volatile Memory Express (NVMe) / Non-Volatile Memory Host Controller Interface Specification (NVMHCIS).
Industry Standard Architecture (ISA), including embodiments such as, but not limited to Extended ISA (EISA), PC/XT-bus / PC/AT-bus / PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP) / Mobile High-Definition Link (MHL), Device Firmware Upgrade (DFU), wireless USB, InterChip USB, IEEE 1395 Interface / Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programable (OTP) ROM / Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 461, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 540. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM / CD-R / CD-RW), Digital Versatile Disk (DVD) (DVD-ROM / DVD-R / DVD+R / DVD-RW / DVD+RW / DVD±RW / DVD+R DL / DVD-RAM / HD-DVD), Blu-ray Disk (BD) (BD-ROM / BD-R / BD-RE / BD-R DL / BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said to be networked together, when one computing device 400 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN / Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency / spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/ sound/vibration sensors, electric current/electric potential/magnetic/radio sensors, environmental/-weather/moisture/humidity sensors, flow/fluid velocity sensors, ionizing radiation/-particle sensors, navigation sensors, position/angle/displacement/distance/speed/-acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/-cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel /oil level sensor, knock sensor, light sensor, MAP sensor, oxygen sensor (o2), parking sensor, radar sensor, torque sensor, variable reluctance sensor, and water-in-fuel sensor.

Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo-capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection / pyrometer, Gardon gauge, Golay cell, heat flux sensor, microbolometer, microwave radiometer, net radiometer, infrared / quartz / resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices uses to put information into and get information out of the computing device 500. There are 3 categories of devices comprising the peripheral sub-module 565, which exist based on their relationship with the computing device 500, input devices, output devices, and input / output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse. [00355] - The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller / gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user’s requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.

Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics / sound cards.

What is claimed is:

1. A system for fluid tank remote monitoring network with predictive analysis, comprising:
a processor of a prediction node connected to a fluid tank sensor node, an environment sensor node, and a user device over a remote network;
a memory on which is stored machine-readable instructions that, when executed by the processor, cause the processor to:
query an admin database for new data acquired from the fluid tank sensor node and from the environment sensor node,
extract a tank ID from the new data,
retrieve, from the admin database, entries corresponding to the extracted tank ID,
retrieve a local environment parameter from the retrieved entries,
search a measurement database for a regional parameter corresponding the local environment parameter,
calculate a difference between a value of the local environment parameter and a value of the regional parameter, and
predict a fluid tank parameter based on the calculated difference.

2. The system of claim 1, wherein the instructions further cause the processor to provide the predicted fluid tank parameter to the user device, and wherein the user device is configured to run a management application configured to adjust fluid tank parameters.

3. The system of claim 1, wherein the measurement database resides on a third-party network connected to a fluid tank local network, and wherein the prediction node is connected to the fluid tank local network.

4. The system of claim 1, wherein the fluid tank parameter is predicted based on a machine learning algorithm.

5. The system of claim 1, wherein the retrieved fluid tank parameter is any of the following:
time until the fluid tank is empty;
fluid level;
temperature;
tank model;
tank capacity; or
tank location.

6. The system of claim 1, wherein the prediction node is connected to a temporary node, and wherein the temporary node is connected to a sensor node and configured to repeat signals from the sensor node.

7. The system of claim 6, wherein the temporary node is directly connected to the user device, and wherein the user device is configured to execute a device management application.

8. A method for fluid tank remote monitoring with predictive analysis, comprising:
querying, by a predictive node, an admin database for new data acquired from a fluid tank sensor node and from an environment sensor node,
extracting, by the predictive node, a tank ID from the new data,
retrieving, by the predictive node, from the admin database, entries corresponding to the extracted tank ID,
retrieving, by the predictive node, a local environment parameter from the retrieved entries,
searching, by the predictive node, a measurement database for a regional parameter corresponding the local environment parameter,
calculating, by the predictive node, a difference between a value of the local environment parameter and a value of the regional parameter, and
predicting a fluid tank parameter based on the calculated difference.

9. The method of claim 8, further comprising providing the predicted fluid tank parameter to the user device, and wherein the user device is running a management application configured to adjust fluid tank parameters.

10. The method of claim 8, wherein the measurement database resides on a third-party network connected to a fluid tank local network, and wherein the predictive node is connected to the fluid tank local network.

11. The method of claim 8, wherein the fluid tank parameter is predicted based on a machine learning process.

12. The method of claim 8, wherein the prediction node is connected to a temporary node, and wherein the temporary node is connected to a sensor node and configured to repeat signals from the sensor node.

13. The method of claim 12, wherein the temporary node is directly connected to a user device, and wherein the user device is configured to execute a fluid tank management application.

14. A non-transitory computer readable medium comprising instructions that, when executed by a processor of a prediction node, cause the processor to perform:
querying an admin database for new data acquired from a fluid tank sensor node and from an environment sensor node,
extracting a tank ID from the new data,
retrieving, from the admin database, entries corresponding to the extracted tank ID,
retrieving a local environment parameter from the entries,
searching a measurement database for a regional parameter corresponding the local environment parameter,
calculating a difference between a value of the local environment parameter and a value of the regional parameter, and
predicting a fluid tank parameter based on the calculated difference.

15. The non-transitory computer readable medium of claim 14, further comprising instructions that, when executed by the processor, cause the processor to provide the predicted fluid tank parameter to a user device, and wherein the user device is running a management application configured to adjust fluid tank parameters.

16. The non-transitory computer readable medium of claim 14, wherein the measurement database resides on a third-party network connected to a fluid tank local network, and wherein the prediction node is connected to the fluid tank local network.

17. The non-transitory computer readable medium of claim 14, wherein the fluid tank parameter is predicted based on a machine learning process.

18. The non-transitory computer readable medium of claim 14, wherein the prediction node is connected to a temporary node connected to a sensor node and configured to repeat signals from the sensor node.

19. The non-transitory computer readable medium of claim 18, wherein the temporary node is directly connected to a user device, and wherein the user device is configured to execute a fluid tank management application.

20. The non-transitory computer readable medium of claim 14, wherein the retrieved fluid tank parameter is any of the following:
time until the fluid tank is empty;
fluid level;
temperature;
tank model;
tank capacity; or
tank location.
